(19) United States
(12) Patent Application Publication
(10) Pub. No.: US 2025/0239012 A1
(43) Pub. Date: Jul. 24, 2025

(54) CONSTRUCTING IMAGE DEPTH INFORMATION BASED ON CAMERA ANGLES

(71) Applicant: Tencent Technology (Shenzhen) Company Limited, Shenzhen (CN)

(72) Inventors: Xiaolong Ning, Shenzhen (CN); Liming Xu, Shenzhen (CN); Xiaoyu PAN, Shenzhen (CN); Yuanheng LI, Shenzhen (CN)

(21) Appl. No.: 19/172,838

(22) Filed: Apr. 8, 2025

Related U.S. Application Data
(63) Continuation of application No. PCT/CN2024/085582, filed on Apr. 2, 2024.

(30) Foreign Application Priority Data
Apr. 13, 2023 (CN) 2023103936686

(51) Int. Cl. G06T 17/00; G06T 7/13

(52) U.S. Cl. CPC G06T 17/00; G06T 7/13

(57) ABSTRACT

Aspects described herein disclose a full-viewing-angle depth information construction method. Aspects provide for obtaining a virtual scene, the virtual scene including a camera configured to present a view of the virtual scene in a direction of at least one viewing angle and at least one virtual object, generating a plurality of surface elements in the virtual scene, a surface element being a plane figure having a direction and a size and wherein each virtual object has at least one surface element. Aspects further provide for obtaining a depth value of each of the plurality of surface elements, the depth value being a distance value between the surface element and the camera and constructing full-viewing-angle depth information of the virtual scene by using the obtained depth values. Aspects provided herein reduce time and processing resources for constructing the full-viewing-angle depth information and while improving quality of the full-viewing-angle depth information.

### CROSS-REFERENCE TO RELATED APPLICATIONS

This application is a continuation application of PCT Application PCT/CN2024/085582, filed Apr. 2, 2024, which claims priority to Chinese Patent Application No. 2023103936686, filed on Apr. 13, 2023, each entitled “FULL-VIEWING-ANGLE DEPTH INFORMATION CONSTRUCTION METHOD AND APPARATUS, DEVICE, AND STORAGE MEDIUM”, and each of which is incorporated herein by reference in its entirety.

### FIELD

Aspects described herein relate to the field of computer technologies, specifically to the field of computer graphics technologies.

### BACKGROUND

With development of computer graphics technologies, full-viewing-angle depth information of a virtual scene is widely used. A full viewing angle is an entire viewing angle (e.g., a viewing angle of 360 degrees) from which any object (such as a user or a camera) views the virtual scene. All virtual objects in the virtual scene may be viewed from the full viewing angle. The full-viewing-angle depth information of the virtual scene refers to information that may be used to indicate a depth value of each virtual object in the virtual scene. A depth value of any virtual object refers to a distance value between the corresponding virtual object and the camera.

### SUMMARY

Aspects described herein provide for a full-viewing-angle depth information construction method and apparatus, a device, and a storage medium, to improve efficiency of constructing full-viewing-angle depth information and quality of the full-viewing-angle depth information.

Aspects described herein provide full-viewing-angle depth information construction methods. One method includes:
obtaining a virtual scene, the virtual scene including a camera and at least one virtual object, and the camera being a component configured to present a view of the virtual scene in a direction of at least one viewing angle;
generating a plurality of surface elements in the virtual scene, the surface element being a plane figure having a direction and a size, and at least one surface element being attached to a surface of each virtual object;
obtaining a depth value of each of the plurality of surface elements in the virtual scene, the depth value being a distance value between the surface element and the camera; and
constructing full-viewing-angle depth information of the virtual scene by using the obtained depth values.

According to another aspect, an apparatus includes:
a processing unit, configured to obtain a virtual scene, the virtual scene including a camera and at least one virtual object, and the camera being a component configured to present a view of the virtual scene in a direction of at least one viewing angle;
the processing unit being further configured to generate a plurality of surface elements in the virtual scene, the surface element being a plane figure having a direction and a size, and at least one surface element being attached to a surface of each virtual object;
the processing unit being further configured to obtain a depth value of each of the plurality of surface elements in the virtual scene, the depth value being a distance value between the surface element and the camera; and
a construction unit, configured to construct full-viewing-angle depth information of the virtual scene by using the obtained depth values.

According to still another aspect, a computer device further includes:
a processor and a computer storage medium.

The processor is adapted to implementing one or more instructions. The computer storage medium stores the one or more instructions. The one or more instructions are adapted to be loaded by the processor to perform the foregoing full-viewing-angle depth information construction method.

According to still another aspect, aspects described herein provides a computer storage medium storing one or more instructions that are adapted to being loaded by a processor to perform the foregoing full-viewing-angle depth information construction method.

According to still another aspect, aspects described herein provides a computer program product, including computer a computer program. The computer program, when executed by the processor, causes the foregoing full-viewing-angle depth information construction method to be implemented.

In an aspect, the plurality of surface elements are generated in the virtual scene, and the distance value between each surface element and the camera is obtained as the depth value of the corresponding surface element in the virtual scene, so that the full-viewing-angle depth information of the virtual scene is constructed by using the depth value of each surface element in the virtual scene. A full-viewing-angle depth information construction procedure provided in an aspect is simple, so that time costs and processing resources (for example, a bandwidth) that are required for constructing the full-viewing-angle depth information can be reduced, and efficiency of constructing the full-viewing-angle depth information can be improved. In addition, because each surface element is attached to a surface of a corresponding virtual object, the depth value of each surface element in the virtual scene can accurately represent a depth value of the corresponding virtual object. Therefore, constructing the full-viewing-angle depth information by using the depth value of each surface element can ensure high accuracy of the constructed full-viewing-angle depth information, and improve quality of the full-viewing-angle depth information. Moreover, when a plurality of surface elements are attached to a surface of each virtual object, a depth value of the same virtual object may be jointly represented by depth values of the plurality of surface elements in the full-viewing-angle depth information. This can further improve accuracy of the depth value of the virtual object, thereby further improving the quality of the full-viewing-angle depth information.

### BRIEF DESCRIPTION OF THE DRAWINGS

FIG. 1a is an illustrative diagram of jointly performing a full-viewing-angle depth information construction method according to aspects described herein;

FIG. 1b is another illustrative diagram of jointly performing a full-viewing-angle depth information construction according to aspects described herein;

FIG. 2 is a flowchart of a full-viewing-angle depth information construction method according aspects described herein;

FIG. 3a is an illustrative diagram of a method for generating a surface element on a surface of a virtual object according aspects described herein;

FIG. 3b is an illustrative diagram of generating a surface element in a virtual scene according to aspects described herein;

FIG. 3c is an illustrative diagram of octahedral mapping according to aspects described herein;

FIG. 4 is an illustrative flowchart of a full-viewing-angle depth information construction method according aspects described herein;

FIG. 5a is a first illustrative diagram of determining a pixel corresponding to a surface element in a mapping template according to aspects described herein;

FIG. 5b is a second illustrative diagram of determining a pixel corresponding to a surface element in a mapping template according aspects described herein;

FIG. 5c is a third illustrative diagram of determining a pixel corresponding to a surface element in a mapping template according aspects described herein;

FIG. 5d is an illustrative diagram of a position relationship between a camera and a surface element according aspects described herein;

FIG. 5e is an illustrative diagram of a depth information map according to aspects described herein;

FIG. 5f is an illustrative diagram of performing information reconstruction on a depth information map according to aspects described herein;

FIG. 5g is an illustrative diagram of another depth information map according to aspects described herein;

FIG. 5h is an illustrative diagram of generating a low-precision information map level by level according to aspects described herein;

FIG. 5i is an illustrative diagram of filling a high-precision information map level by level according to aspects described herein;

FIG. 6 is an illustrative diagram of a structure of a full-viewing-angle depth information construction apparatus according to aspects described herein; and

FIG. 7 is an illustrative diagram of a computer device according to aspects described herein.

### DETAILED DESRIPTION

The following describes the technical solutions according to aspects provided herein with reference to the accompanying drawings.

Aspects described herein provide for, based on a computer vision (CV) technology and a computer graphics technology in an artificial intelligence (AI) technology, a method for constructing full-viewing-angle depth information of a virtual scene based on a surface element. The AI technology is a theory, method, technology, and application system that uses a digital computer or a machine controlled by a digital computer to simulate, extend, and expand human intelligence, perceive an environment, acquire knowledge, and use knowledge to obtain an optimal result. In other words, AI is a comprehensive technology in computer science. AI mainly understands the essence of intelligence and produce a new intelligent machine that can react in a manner similar to human intelligence, so that the intelligent machine has a plurality of functions such as perception, inference, and decision-making. The CV technology in the AI technology is a science that studies how to use a machine to “see”, and furthermore, is a technology of performing machine vision processing such as recognition and measurement on a target by using a camera and a computer instead of human eyes, and further performing graphic processing, so that the computer processes the target into an image more suitable for human eyes to observe, or an image transmitted to an instrument for detection. The computer graphics technology in the AI technology is a science of converting a two-dimensional or three-dimensional image into a grid form of a computer display by using a mathematical algorithm. In short, main research content of computer graphics is to research related principles and algorithms about how to represent a graph in a computer and perform calculation, processing, and displaying on the graph by using the computer.

In aspects described herein, the surface element may be referred to as a discrete surface element, and is a plane figure having a direction and a size, such as a circle, an ellipse, a square, or a hexagon. A basic constituent element (which may be referred to as surface element information) of a surface element may include but is not limited to the following points: (1) world space coordinates, for example, world space coordinates of a center point of the surface element, where the world space coordinates are three-dimensional coordinates in a world space coordinate system, and the world space coordinate system may also be referred to as an absolute coordinate system, and does not change with a viewing angle or another factor; (2) a normal vector, that is, a vector represented by a straight line perpendicular to the surface element, which may indicate a normal direction of the surface element, where the normal direction mentioned herein is a direction of the surface element; and (3) size information, that is, information used for indicating a size of the surface element, where for example, when the surface element is a circle, the size information may be a circle radius (a radius for short).

The virtual scene may be understood as a scene that may be displayed on a screen of a device. Specifically, the virtual scene may be a scene obtained by performing digital simulation on a scene in a real world, for example, a scene obtained by simulating an autonomous driving scene or a scenic resort visit scene in the real world. Alternatively, the virtual scene may be a semi-simulated semi-fictional scene, for example, a scene in which fictional characters are superimposed in a simulated world corresponding to a real world. Alternatively, the virtual scene may be an entirely fictional scene, for example, a game scene or a scene in a television drama or in a movie.

The virtual scene may include at least one virtual object. The virtual object may be a static object element in the virtual scene, such as a virtual lawn or a virtual building. Alternatively, the virtual object may be a movable object in the virtual scene, such as a virtual character in the game scene or a virtual animal in the game scene. A virtual object in the virtual scene may be a static object element (e.g., non-moving), or a movable object, or may include both a static object element and a movable object. Further, the virtual scene may further include a camera. The camera is a component configured to present a view of the virtual scene in a direction of at least one viewing angle. A position of the camera in the virtual scene is not limiting. For example, the camera may be located at a position of a virtual object in the virtual scene, or located at any position in the virtual scene other than a position of each virtual object.

Based on the foregoing definitions, the following describes a principle of the method for constructing full-viewing-angle depth information of a virtual scene based on a surface element according to aspects described herein. Specifically, a general principle of the method is as follows: First, at least one surface element may be separately generated and attached to a surface of each virtual object in a virtual scene. Then, a depth value of each surface element in the virtual scene may be obtained, a depth value of any surface element in the virtual scene being a distance value between the corresponding surface element and the camera. Next, full-viewing-angle depth information of the virtual scene may be constructed by using the depth value of each surface element in the virtual scene. The full-viewing-angle depth information of the virtual scene may then be constructed based on the surface element, so that a full-viewing-angle depth information construction procedure is simple, which can reduce time costs and processing resources (for example, a bandwidth) that are required for constructing the full-viewing-angle depth information, and improve efficiency of constructing the full-viewing-angle depth information. In addition, because each surface element is attached to a surface of a corresponding virtual object, the depth value of each surface element in the virtual scene can accurately represent a depth value of the corresponding virtual object. Therefore, constructing the full-viewing-angle depth information by using the depth value of each surface element can ensure high accuracy of the constructed full-viewing-angle depth information, and improve quality of the full-viewing-angle depth information. Moreover, when a plurality of surface elements are attached to a surface of each virtual object, a depth value of the same virtual object may be jointly represented by depth values of the plurality of surface elements in the full-viewing-angle depth information. This can further improve accuracy of the depth value of the virtual object, thereby further improving the quality of the full-viewing-angle depth information.

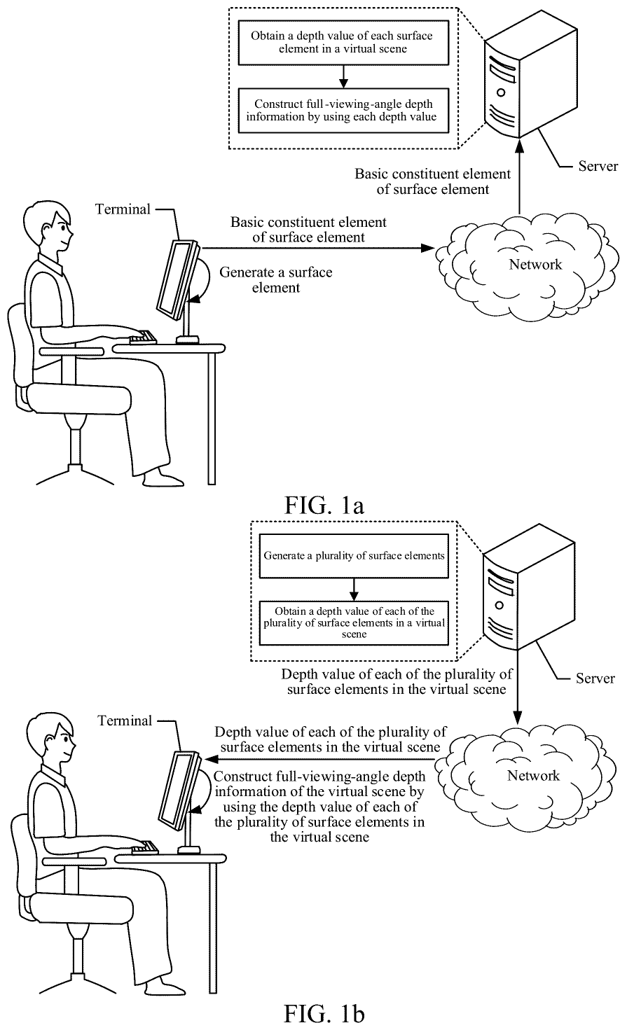

Aspects described herein may be performed by a computer device, and the computer device may be a terminal or a server. Additionally or alternatively, aspects described herein may be jointly performed by a terminal and a server. For example, the terminal is responsible for separately generating and attaching, to the surface of each virtual object in the virtual scene, the at least one surface element, and then transmitting a basic constituent element (such as world space coordinates, a normal vector, and size information) of the surface element to the server, so that the server performs, based on the basic constituent element, the operation of obtaining the depth value of each surface element in the virtual scene and the operation of constructing the full-viewing-angle depth information, as shown in FIG. 1a. In another example, the server is responsible for generating and attaching a plurality of surface elements, obtaining a depth value of each surface element in the virtual scene, and then transmitting the depth value of each surface element in the virtual scene to the terminal, so that the terminal is responsible for constructing the full-viewing-angle depth information of the virtual scene by using the depth value of each surface element in the virtual scene, as shown in FIG. 1b. Additionally or alternatively, the server is responsible for generating a plurality of surface elements, and transmitting basic constituent elements of the plurality of surface elements to the terminal, so that the terminal obtains a depth value of each surface element in the virtual scene based on the basic constituent elements, returns the obtained depth value to the server, and triggers the server to construct the full-viewing-angle depth information of the virtual scene by using the received depth value.

The foregoing terminal may include but is not limited to a smartphone, a computer (for example, a tablet computer, a notebook computer, or a desktop computer), a smart wearable device (for example, a smartwatch or smart glasses), a smart voice interaction device, a smart household appliance (for example, a smart television), an on-board terminal, an aircraft, and/or the like. The server may be an independent physical server, a server cluster or distributed system including a plurality of physical servers, or a cloud server providing a basic cloud computing service such as a cloud service, a cloud database, cloud computing, a cloud function, cloud storage, a network service, cloud communication, a middleware service, a domain name service, a security service, a content delivery network (CDN), and a big data and artificial intelligence platform. Terminal and server structure is not limiting.

Based on the foregoing descriptions, aspects described herein provide a full-viewing-angle depth information construction method. The method may be performed by a computer device (e.g., a terminal or a server as described above), or may be jointly performed by one or more computer devices. For ease of description, the following aspects will be described with a computer device performing the method. The method may include the following operations S201 to S203:

S201: Obtain a virtual scene, and generate a plurality of surface elements in the virtual scene.

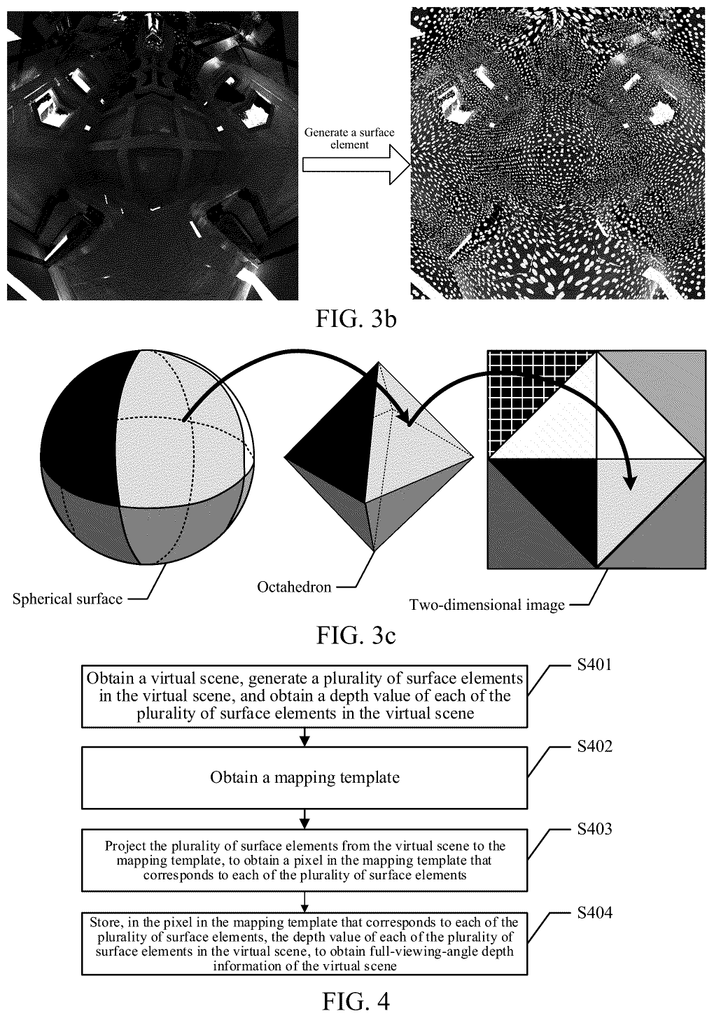

The computer device may traverse each virtual object in the virtual scene. For a currently traversed virtual object, the computer device may generate at least one surface element based on a position of the currently traversed virtual object in the virtual scene, and attach the at least one surface element to a grid body surface (a surface for short) of the currently traversed virtual object, different surface elements corresponding to different attachment positions. The surface element may be understood as that the surface element “clinging” to the surface of the virtual object. For an illustrative diagram of generating the surface element and attaching the surface element to the surface of the virtual object, see FIG. 3a below. Further, after the at least one surface element is generated and attached to the surface of the currently traversed virtual object, the computer device may traverse another virtual object in the virtual scene, until each virtual object in the virtual scene is traversed, and ending surface element generation operation.

Through operation S201, at least one surface element may be attached to a surface of each virtual object in the virtual scene. Quantities of surface elements attached to surfaces of different virtual objects may be the same or different. This is not limited. In addition, attributes (such as sizes and directions) of different surface elements corresponding to each virtual object may be the same or different. This is not limited either. For example, for a schematic diagram of generating the surface element in the virtual scene, refer to FIG. 3b. In an aspect, a surface element-based scene representation system may be established by making the surface element cling to a grid body surface of each virtual object in the virtual scene. These surface elements are used to approximately represent geometrical information of the virtual scene, so that the geometrical information of the virtual scene can be expressed more simply.

Because each surface element is attached to a surface of a corresponding virtual object, a depth value of any virtual object in the virtual scene may be represented by a depth value of each surface element attached to a surface of the virtual object in the virtual scene. Based on this, after generating the plurality of surface elements in the virtual scene in operation S201, the computer device may perform operation S202 to obtain a depth value of each of the plurality of surface elements in the virtual scene, and subsequently construct full-viewing-angle depth information of the virtual scene by using the depth value of each of the plurality of surface elements in the virtual scene.

S202: Obtain a depth value of each of the plurality of surface elements in the virtual scene.

A depth value of any surface element in the virtual scene is a distance value between the corresponding surface element and a camera. The computer device may obtain a distance value between each surface element and the camera, and then separately use the distance value between each surface element and the camera as a depth value of the corresponding surface element in the virtual scene. Because at least one view of the virtual scene is presented on a display screen by using the camera, in an actual application, the depth value may be used as a depth rendering parameter. As a result, the corresponding surface element or virtual object can be subsequently rendered and displayed based on the depth rendering parameter.

For example, a method for obtaining the distance value between a surface element and the camera may be: obtaining world space coordinates of the surface element, obtaining world space coordinates of the camera, and calculating an Euclidean distance between the corresponding surface element and the camera based on the world space coordinates of the surface element and the world space coordinates of the camera. The result is a distance value between the corresponding surface element and the camera. The world space coordinates are coordinates in a world space coordinate system, wherein the world space coordinate system does not change based on viewing angles or other factors. Therefore, calculating the distance value based on the world space coordinates can prevent deviations in distance value caused by a change of viewing angle, ensuring accuracy of the distance value and the depth value of each surface element in the virtual scene.

Other methods for calculating the distance value between a surface element and the camera may be possible. For example, the computer device may create a scene coordinate system based on a point in the virtual scene, and calculate a Euclidean distance between the surface element and the camera based on position coordinates of the surface element in the scene coordinate system and position coordinates of the camera in the scene coordinate system, wherein the Euclidean distance is the distance value between the surface element and the camera. The Euclidean distance is a Euclidean metric. In mathematics, the Euclidean metric is a distance between two points in Euclidean space.

S203: Construct full-viewing-angle depth information of the virtual scene by using the obtained depth values, the obtained depth value including the depth value of each of the plurality of surface elements in the virtual scene.

For example, the computer device may represent the full-viewing-angle depth information of the virtual scene by using a two-dimensional image. In this example, operation S203 may be implemented as follows.

The computer device obtains a mapping template. The mapping template is a two-dimensional image. The mapping template may include a plurality of pixels, and one pixel is used for storing one depth value. The plurality of surface elements are projected from the virtual scene to the mapping template to obtain a pixel in the mapping template corresponding to each of the plurality of surface elements. A surface element may be mapped to the mapping template in an octahedral mapping manner. Octahedral mapping is a spherical parameterized mapping manner, whose principle is a parameter mapping manner in which a spherical parameter is mapped to an octahedron and then further mapped to a two-dimensional image, as shown in FIG. 3c. After obtaining the corresponding pixels in the mapping template, the computer device may store, in each corresponding pixel, the obtained depth value of the corresponding surface element in the the plurality of surface elements in the virtual scene, to obtain the full-viewing-angle depth information of the virtual scene.

The full-viewing-angle depth information may be widely used in various post-processing operations such as ray tracing and image rendering. When the full-viewing-angle depth information is used in the post-processing operation of ray tracing, the full-viewing-angle depth information is represented by using a two-dimensional image, so that an entire ray tracing procedure can subsequently be completed on the two-dimensional image. Completing ray tracing on a two-dimensional image may improve ray tracing efficiency.

In another example, the computer device may represent the full-viewing-angle depth information of the virtual scene by using a table. In this example, operation S203 may be implemented as follows.

The computer device may construct a blank table. The computer device may then obtain a surface element identifier of each surface element and an object identifier of each virtual object. The computer device may then and then associatively store the object identifier of each virtual object, the surface element identifier of each surface element, and the depth value of each surface element in the virtual scene in the blank table based on a correspondence between a virtual object and a surface element, to obtain the full-viewing-angle depth information of the virtual scene.

In the following example, the virtual scene includes two virtual objects, and with respective object identifiers as “object A” and “object B”. Two surface elements are attached to a surface of each of the two virtual objects. Surface element identifiers of the surface elements are, respectively, a surface element 1, a surface element 2, a surface element 3, and a surface element 4. Depth values of the surface elements in the virtual scene are, respectively, 0.2, 0.5, 0.3, and 0.7. For the constructed full-viewing-angle depth information, refer to the following Table 1.

TABLE 1

| Virtual object | Surface element | Depth value |
|---|---|---|
| Object A | Surface element 1 | 0.2 |
| | Surface element 2 | 0.5 |
| Object B | Surface element 3 | 0.3 |
| | Surface element 4 | 0.7 |

In this example, the plurality of surface elements are generated in the virtual scene, and the distance value between each surface element and the camera obtained as the depth value of the corresponding surface element in the virtual scene. The full-viewing-angle depth information of the virtual scene is constructed by using the depth value of each surface element in the virtual scene. A full-viewing-angle depth information construction procedure as described herein is simple, reducing time and processing costs (e.g., bandwidth) required for constructing the full-viewing-angle depth information. This also improves efficiency of constructing the full-viewing-angle depth information. In addition, because each surface element is attached to a surface of a corresponding virtual object, the depth value of each surface element in the virtual scene can accurately represent a depth value of the corresponding virtual object. Therefore, constructing the full-viewing-angle depth information by using the depth value of each surface element ensures high accuracy of the constructed full-viewing-angle depth information, and improves quality of the full-viewing-angle depth information. Moreover, when a plurality of surface elements are attached to a surface of a virtual object, a depth value of the virtual object may be jointly represented by depth values of the plurality of surface elements in the full-viewing-angle depth information. This can further improve accuracy of the depth value of the virtual object, thereby further improving the quality of the full-viewing-angle depth information.

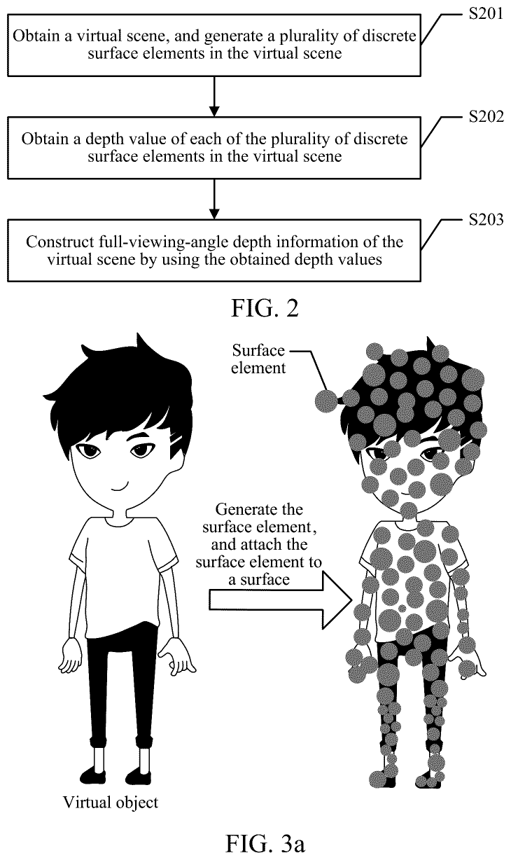

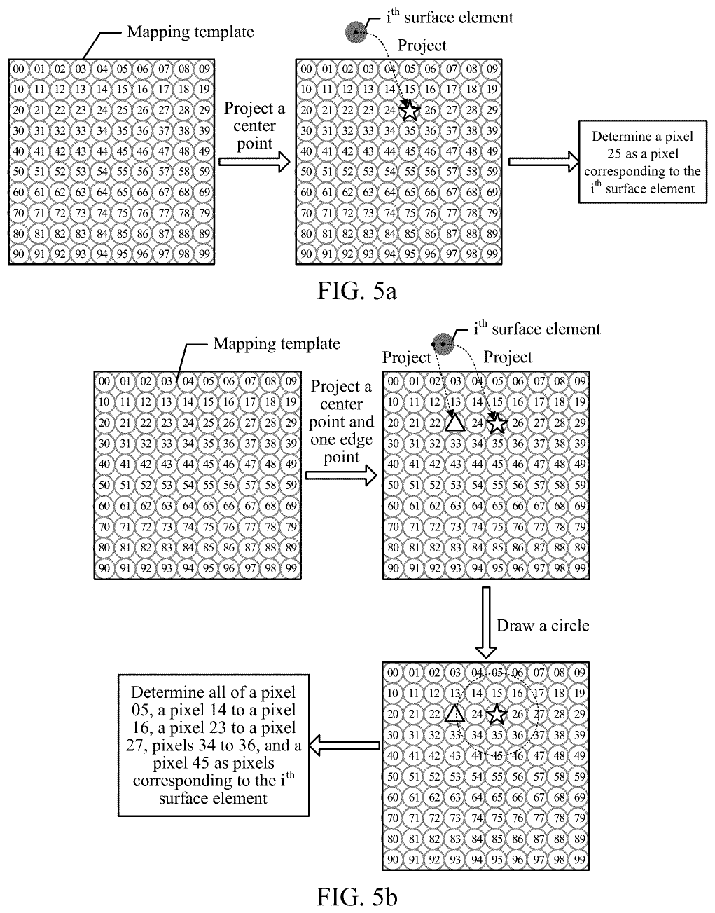

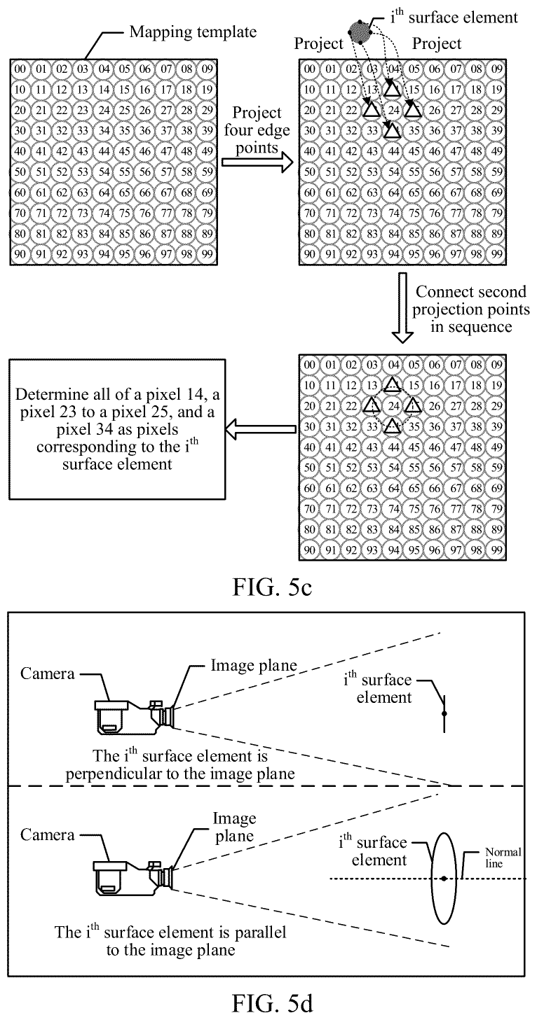

FIG. 4 is an illustrative flowchart of a full-viewing-angle depth information construction method according aspects described herein. The full-viewing-angle depth information construction method described below may be based on the method illustrated in FIG. 2. According to an aspect, The full-viewing-angle depth information construction method may include the following operations S401 to S404:
S401: Obtain the virtual scene, generate the plurality of surface elements in the virtual scene, and obtain the depth value of each of the plurality of surface elements in the virtual scene.
S402: Obtain the mapping template, the mapping template including the plurality of pixels, and one pixel being used for storing one depth value.
S403: Project the plurality of surface elements from the virtual scene to the mapping template, to obtain the pixel in the mapping template that corresponds to each of the plurality of surface elements. The projection method of S403 may be implemented in one or ways. Several projection methods are enumerated below; other projection methods may also be used. Different projection methods are further illustrated in FIGS. 5a, 5b, and 5c.

In an illustrative implementation, the computer device may perform a projection operation on each surface element based on a corresponding center point of each surface element, to obtain the pixel in the mapping template that corresponding to each surface element. For example, for an i^{th} surface element (i∈[1, I], where I is a total quantity of the surface elements), the computer device may project, based on a direction vector from a corresponding center point of the i^{th} surface element and the camera, the corresponding center point to the mapping template and obtain a first projection point. Then, the computer device may use a pixel in the mapping template, wherein the pixel is located at the first projection point and corresponds to the i^{th} surface element. For example, as illustrated in FIG. 5a, a circle is used to represent a pixel in the mapping template, and the first projection point is a point represented by a five-pointed star. Because a pixel 25 in the mapping template is located at the first projection point, the pixel 25 corresponds to the i^{th} surface element. Projecting the corresponding center point of the surface element to the mapping template to obtain the corresponding pixel in the mapping template in this manner avoids projection of the entire surface element, reducing necessary processing resources required and improving projection efficiency. In addition, because the center point can accurately represent a position of the surface element, projecting the center point to obtain the corresponding pixel for the surface element in the mapping template maintains accuracy of the pixel.

Additionally or alternatively, projection may vary based on a shape of the surface element. For example, as illustrated in FIG. 5b, when a shape of the surface element is a circle, the computer device may perform a projection operation on each surface element based on a radius of the surface element to obtain one or more corresponding pixels in the mapping template. For example, for an i^{th} surface element, the computer device may project, based on a direction vector between a center point of the i^{th} surface element and the camera, the corresponding center point from the virtual scene to the mapping template, to obtain a first projection point. The computer device may then project, based on a direction vector between an edge point of the i^{th} surface element and the camera, a corresponding edge point to the mapping template, and obtain a second projection point. In this example, an edge points is a point selected from an edge of the i^{th} surface element based on the radius of the i^{th} surface element. Additionally or alternatively, the computer device may obtain a circular region on the mapping template by using the first projection point as a circle center and a distance between the first projection point and the second projection point as a radius. The computer device may then use each pixel in the mapping template located in the circular region as a corresponding pixel; that is, each pixel in the circular region drawn on the mapping template corresponds to the i^{th} surface element. This may include a pixel on an edge of the circular region. As depicted in FIG. 5b, a circle represents a pixel in the mapping template, the first projection point is represented by a five-pointed star, the second projection point is represented by a triangle, and the circular region drawn based on the first projection point and the second projection point is a dashed-line circle region. In this case, a pixel 05, a pixel 14 to a pixel 16, a pixel 23 to a pixel 27, pixels 34 to 36, and a pixel 45 in the dashed-line circle region in the mapping template may all be used as pixels in the mapping template that correspond to the i^{th} surface element. Projecting the surface element to the mapping template in this method provides for the obtained pixels to have a shape resembling the shape of the surface element, improving accuracy of the obtained pixels. In addition, when a plurality of pixels in the mapping template correspond to each surface element, that there may be substantially no voids or few voids in a depth information map subsequently obtained from the mapping template. Therefore, quality of the depth information map can be improved.

The edge point may be specified in advance, or may be determined by the computer device in real time while performing operation S403. If the edge point is determined by the computer device in real time, before projecting the corresponding edge point from the virtual scene to the mapping template, the computer device first obtains surface element information of the i^{th} surface element, wherein the surface element information includes the radius, world space coordinates of the center point, and a normal vector of the i^{th} surface element. Then, the computer device determines the edge of the i^{th} surface element in the virtual scene based on the obtained surface element information and selects a point from the determined edge (e.g., a plurality of points along the determined edge) as the edge point of the i^{th} surface element. The computer device may select the edge point randomly or based on predetermined logic. Determining the edge point in real time can reduce consumption of processing resources and internal memory space for pre-storing related information of the edge point, saving processing resources and internal memory space, and improving performance of the computer device.

In another aspect, the computer device may perform a projection operation on each surface element based on only an edge point of the surface element For example, for an i^{th} surface element, the computer device may first select K edge points from an edge of the i^{th} surface element, K being an integer greater than 2, and project, based on a direction vector between each edge point and the camera, the corresponding edge point from the virtual scene to the mapping template to obtain K second projection points. The computer device may then connect the K second projection points on the mapping template to obtain a closed region, wherein each pixel in the closed region is a pixel corresponding to the i^{th} surface element. A pixel located in the closed region herein may include a pixel on an edge of the closed region. For example, as illustrated in FIG. 5c, a circle represents a pixel in the mapping template, four second projection points are represented by four triangles, and a closed region is illustrated by connecting the four second projection points in a dashed-line region. In this case, a pixel 14, a pixel 23, a pixel 25, and a pixel 34 in the dashed-line region in the mapping template may all be used as pixels corresponding to the i^{th} surface element. Projecting the surface element to the mapping template in this manner can make a shape formed by obtained pixels similar to that of the surface element. This method may also ensure that there a plurality of pixels in the mapping template correspond to each surface element, so that there are substantially no voids or few voids in a depth information map obtained based on the mapping template. Therefore, quality of the depth information map can be improved. Additionally or alternatively, this method may be applied to a surface element of any shape.

Any two adjacent second projection points (e.g., adjacent with respect to other second projection points) may be connected by using a straight line or by using a curve. Therefore, a shape of the closed region obtained by connecting the K second projection points may be the same as or different from that of the i^{th} surface element. In addition, the K edge points mentioned in this specific implementation may be specified in advance, or may be determined by the computer device in real time while performing operation S403. Further, the computer device may determine the K edge points in real time in any one of the following manners: (1) randomly selecting K points from the edge of the i^{th} surface element as edge points; (2) selecting K points at equal intervals from the edge of the i^{th} surface element as edge points; and (3) selecting the K edge points from the edge of the i^{th} surface element based on an edge point selection policy adapted to the shape of the i^{th} surface element. Edge point selection policies corresponding to different shapes may be preset. For example, an edge point selection policy corresponding to a circle is used for indicating to select K points at equal intervals from a circle edge as edge points. An edge point selection policy corresponding to a polygon (such as a square or a hexagon) is used for indicating to select vertexes on edges as edge points. Selecting the K edge points in consideration of the shape of the surface element can make the shape of the finally obtained closed region similar to that of the i^{th} surface element, so that accuracy of the pixel is improved.

For the foregoing aspects of operation S403:
(1) In an actual application, the computer device may randomly select one of the foregoing three specific implementations, to project the i^{th} surface element to the mapping template. Alternatively, the computer device may select one of the foregoing aspects based on the normal vector between the i^{th} surface element and the camera. For example, when the shape of the i^{th} surface element is a circle, the computer device may determine a position relationship between the i^{th} surface element and an image plane of the camera (that is, a plane on which a lens is located) based on the normal vector of the i^{th} surface element, and select a projection method (e.g., as illustrated in FIGS. 5a, 5b, and 5c) based on the position relationship between the i^{th} surface element and the image plane of the camera. The position relationship between the i^{th} surface element and the image plane of the camera may include a perpendicular relationship, a parallel relationship, or an oblique relationship.

Specifically, the computer device may determine the position relationship between the i^{th} surface element and the image plane of the camera by determining a position relationship between the normal vector of the i^{th} surface element and the image plane of the camera. Because the normal vector of the i^{th} surface element is perpendicular to the i^{th} surface element, if the normal vector of the i^{th} surface element is perpendicular to the image plane of the camera, it may be determined that the position relationship between the i^{th} surface element and the image plane of the camera is the parallel relationship; if the normal vector of the i^{th} surface element is parallel to the image plane of the camera, it may be determined that the position relationship between the i^{th} surface element and the image plane of the camera is the perpendicular relationship; and if the normal vector of the i^{th} surface element is oblique to the image plane of the camera, it may be determined that the position relationship between the i^{th} surface element and the image plane of the camera is the oblique relationship.

If the i^{th} surface element and the image plane of the camera are perpendicular to each other, the i^{th} surface element is imaged in the camera as a line segment (as shown in the upper figure in FIG. 5d), and a midpoint of the line segment is the center point of the i^{th} surface element. In this case, the camera can accurately see the center point of the i^{th} surface element. In this case, the projection method illustrated in FIG. 5a may be selected for projecting the center point of the i^{th} surface element to the mapping template. In other words, based on the normal vector of the i^{th} surface element indicating that the i^{th} surface element and the image plane of the camera are perpendicular to each other, only the center point of the i^{th} surface element may be projected to the mapping template.

If the i^{th} surface element and the image plane of the camera are parallel to each other, the i^{th} h surface element may be imaged in the camera as a circle (as shown in the lower figure in FIG. 5d). In this case, the camera can see all content of the i^{th} surface element. In this case, a projection shape of the i^{th} surface element in the mapping template may be a circle. Therefore, the projection method illustrated in FIG. 5b may be selected for projecting the center point and one edge point of the i^{th} surface element to the mapping template. In other words, based on the normal vector of the i^{th} surface element indicating that the i^{th} surface element and the image plane of the camera are parallel to each other, the center point and one edge point of the i^{th} surface element may be projected to the mapping template.

If the i^{th} surface element and the image plane of the camera are oblique to each other, the i^{th} surface element is imaged in the camera as an ellipse (not shown in FIG. 5d). In this case, the camera can see some content of the i^{th} surface element. In this case, the projection method illustrated in FIG. 5c may be selected to project K edge points of the i^{th} surface element to the mapping template and determine the corresponding pixels in a manner of drawing the closed region by using the K second projection points. In other words, based on the normal vector of the i^{th} surface element indicating that the i^{th} surface element and the image plane of the camera are oblique to each other, only the plurality of edge points of the i^{th} surface element are projected to the mapping template.

A projection manner of the i^{th} surface element may be determined based on the position relationship between the i^{th} surface element and the image plane of the camera. As a result, a projection result of the i^{th} surface element better conforms to visual effects of the camera for the i^{th} surface element, improving accuracy of the projection result of the i^{th} surface element. Other projection methods, or other methods of selecting projection methods based on the position relationship between the i^{th} surface element and the image plane of the camera, may also be possible.
(2) In the foregoing aspects, when the computer device projects, based on a direction vector between a point and the camera, a corresponding point to the mapping template to obtain the projection point, the computer device may further base projection on an octahedral mapping operation. For example, the computer device may project, based on the direction vector between the point and the camera, the corresponding point to the mapping template through the octahedral mapping operation by normalizing each vector element in the direction vector between the point and the camera, so that a modulus of a normalized direction vector is 1. In this way, the normalized direction vector can be used for representing a position of the point on a spherical surface constructed by using the camera as a center. Then, the normalized direction vector may be converted into two-dimensional coordinates by using target pseudocode, the two-dimensional coordinates obtained through conversion being coordinates of the projection point of the point in the mapping template. The target pseudocode is specifically as follows:

```
  //InVector3 is a three-dimensional direction vector input, and a return value of the
function is two-dimensional coordinates OutOct2 obtained through conversion
  float2 float3_to_oct (in float3 InVector3)
  {
    //OutOct2 is a final two-dimensional coordinate output, and an abs function
refers to an absolute value solving operation
    float2 OutOct2=InVector3.xy *
(1.0/(abs(InVector3.x)+abs(InVector3.y)+abs(InVector3.z)));
    //factor is a coefficient used for correcting a positive or negative value of
OutOct2
    float2 factor;
    if (InVector3.x>0&&InVector3.y>0)
    {
      factor=float2 (1, 1);
    }
    else if (InVector3.x>0&&InVector3.y<=0)
    {
      factor=float2 (1, −1);
    }
    else if (InVector3.x<=0&&InVector3.y>0)
    {
      factor=float2 (−1, 1);
    }
    else
    {
      factor=float2 (−1, −1);
    }// if the x component of InVector3 is greater than 0, a value of the x
component is 1, or if the x component of InVector3 is not greater than 0, a value of the x component
is −1; and if the y component of InVector3 is greater than 0, a value of the y component is 1, or if
the y component of InVector3 is not greater than 0, a value of the y component is −1
    if (InVector3.z<=0)
    {
      OutOct2=(1−abs (OutOct2.yx)) * factor;
    }//perform positive or negative correction if a z component of InVector3 is less
than or equal to 0
    return OutOct2;
  }
```

S404: Store, in the pixel in the mapping template corresponding to each of the plurality of surface elements, the obtained depth value of each of the plurality of surface elements in the virtual scene, to obtain the full-viewing-angle depth information of the virtual scene.

For example, as described in operation S404, the computer device may first store, in the pixel in the mapping template that corresponds to each of the plurality of surface elements, the obtained depth value of each of the plurality of surface elements in the virtual scene to obtain a depth information map. A pixel in the depth information map that does not store a depth value of any surface element is an invalid pixel, that is, the invalid pixel does not store any depth value, and may be understood as an empty pixel. The computer device may determine the full-viewing-angle depth information of the virtual scene based on the depth information map.

According to an aspect, because the pixels in the mapping template are all discrete points, if the pixel in the mapping template that corresponds to each surface element is determined by using the first specific implementation (that is, projecting only a center point of each surface element) in operation S403, each surface element corresponds to one pixel in the mapping template, there may be many empty pixels (that is, pixels that do not store any depth values) in the depth information map obtained after the depth value of each surface element in the virtual scene is stored in the corresponding pixel in the mapping template, and these empty pixels may form one or more voids, as shown in FIG. 5e. In this case, if the depth information map is directly used as the full-viewing-angle depth information of the virtual scene, the full-viewing-angle depth information has poor quality (for example, a small amount of depth value information is included, and visual effects are poor). Based on this, to improve the quality of the full-viewing-angle depth information, the computer device may perform information reconstruction on the invalid pixel in the depth information map based on an information reconstruction policy, to obtain a reconstructed depth information map, and use the reconstructed depth information map as the full-viewing-angle depth information of the virtual scene. As shown in FIG. 5f, information reconstruction is performed on the invalid pixel in the depth information map, so that a quantity of voids in the finally obtained full-viewing-angle depth information can be effectively reduced, and the quality of the full-viewing-angle depth information can be improved.

In another specific implementation, if the pixel in the mapping template that corresponds to each surface element is determined by using the second specific implementation (that is, projecting a center point and one edge point of each surface element) in operation S403, or is determined by using the third specific implementation (that is, projecting a plurality of edge points of each surface element) in operation S403, each surface element may correspond to a plurality of pixels in the mapping template, and there may substantially be no voids or few voids in the depth information map obtained after the depth value of each surface element in the virtual scene is stored in the corresponding pixel in the mapping template, as shown in FIG. 5g. In this case, the computer device may directly use the depth information map as the full-viewing-angle depth information of the virtual scene, to improve efficiency of constructing the full-viewing-angle depth information. Certainly, in this case, to further improve the quality of the full-viewing-angle depth information, the computer device may alternatively perform information reconstruction on the invalid pixel in the depth information map based on the information reconstruction policy, and use the reconstructed depth information map as the full-viewing-angle depth information of the virtual scene. This is not limited.

The foregoing information reconstruction policy may be a pull-push policy (pull means constructing low-precision Mip layer by layer according to a specific rule by using high-precision Mip (information map); and push means filling an invalid pixel (that is, a pixel that does not store a depth value) in the high-precision Mip layer according to a specific rule by layer by using the low-precision Mip constructed in the pull procedure). Based on this, a specific implementation in which the computer device performs information reconstruction on the invalid pixel in the depth information map based on the information reconstruction policy, to obtain the reconstructed depth information map may include the following operations s11 and s12:

s11: Generate a low-precision information map level by level based on the depth information map, to obtain a target information map.

During level-by-level generation of the low-precision information map, a depth value stored in any pixel in a (k+1) th-level information map is determined based on depth values stored in a plurality of pixels in a k^{th}-level information map. The target information map obtained in operation s11 includes only one pixel, and a depth value is stored in the included pixel. In an aspect, k∈[1, K−1], K is a precision level corresponding to the target information map, and a zeroth-level information map is the depth information map. In addition, precision of any information map is in positive correlation with a quantity of pixels included in the corresponding information map. In other words, in a process of performing operation s11, precision of the zeroth-level information map (that is, the depth information map) is the highest.

Generating the low-precision information map level by level based on the depth information map means according to a principle of generating information maps from high to low precision, first generating a low-precision information map (that is, a first-level information map) based on the depth information map (that is, the zeroth-level information map), then generating a lower-precision information map (that is, a second-level information map) based on the first-level information map, then generating a lower-precision information map (that is, a third-level information map) based on the second-level information map, and so on, until the target information map (that is, an information map including only one pixel in which a depth value is stored) is generated. In other words, during specific implementation of operation s11, a value of k increases stepwise. To be specific, k is first valued to 1, then 2, and so on, until the value of k is K−1.

According to an aspect of operation s11, the computer device may group a pixel in the k^{th}-level information map. Specifically, the pixel in the k^{th}-level information map may be grouped in a manner that a preset quantity (for example, four) of pixels is one group. After a grouping result is obtained, an image template used for generating the (k+1)^{th}-level information map may be determined based on the grouping result. No pixel in the image template stores a depth value. One pixel in the image template corresponds to one pixel group in the grouping result. Different pixels correspond to different pixel groups. Then, the computer device may traverse each pixel in the image template, and use a currently traversed pixel as a current pixel. A pixel group corresponding to the current pixel is obtained from the grouping result, and a valid pixel is selected from the obtained pixel group, the valid pixel being a pixel storing a depth value. If at least one valid pixel is selected, a mean operation (or weighted averaging) is performed on a depth value stored in each selected valid pixel, a value obtained through the mean operation (or weighted averaging) is used as a depth value, and the depth value is stored in the current pixel; or if no valid pixel is selected, it is determined that the current pixel is empty, that is, an operation of filling the current pixel with a depth value is not performed. Traversing is continued until each pixel in the image template is traversed, to obtain the (k+1)^{th}-level information map. Alternatively, after obtaining the pixel group corresponding to the current pixel, the computer device may not perform a valid pixel selection operation, but directly performs a mean operation (or weighted averaging) on a depth value stored in each pixel in the obtained pixel group, uses a value obtained through the mean operation (or weighted averaging) as a depth value, and stores the depth value in the current pixel.

For example, as shown in the left figure in FIG. 5h, it is assumed that the depth information map (that is, the zeroth-level information map) includes 16 pixels, and the computer device performs grouping by using four pixels as one group. In this case, the computer device may first group the pixels in the depth information map, to obtain four pixel groups, one pixel group including four pixels. Then, an image template used for generating the first-level information map may be determined. The image template includes four pixels, and one pixel corresponds to one pixel group. For the first pixel in the image template, a pixel group corresponding to the first pixel may be selected from the four pixel groups corresponding to the depth information map (that is, four corresponding pixels are selected) based on a correspondence between a pixel and a pixel group shown in the left figure in FIG. 5h. Then, the four pixels in the selected pixel group are screened, and if a pixel does not store a depth value, it is determined that the pixel is invalid. Because the four pixels in the selected pixel group are all valid, a mean operation may be directly performed on depth values stored in the four selected pixels. In this case, a weight of each pixel is ¼. Then, a mean value obtained through the operation is specified as a depth value and stored in the first pixel. For the other three pixels in the image template, an operation the same as that on the first pixel is performed. In this way, the first-level information map can be obtained.

Further, the computer device may continue to group the pixels in the first-level information map, to obtain one pixel group, and determine an image template for generating the second-level information map. The image template includes one pixel. For the one pixel, four pixels in the one pixel group obtained through grouping may be screened. Because the four pixels in the one pixel group are all valid, a mean operation may be directly performed on depth values stored in the four pixels in the one pixel group, and then a mean value obtained through the operation is specified as a depth value and stored in the pixel in the image template, to obtain the second-level information map, as shown in the right figure in FIG. 5h. A dashed-line dot in the right figure in FIG. 5h indicates a pixel in the first-level information map, a solid-line dot indicates a pixel in the second-level information map, and the numeral ¼ indicates a weight of each pixel in the first-level information map. Because the second-level information map includes only one pixel, and a depth value is stored in the pixel, a low-precision Mip generation procedure may be ended, and the second-level information map is used as the target information map.

In an aspect, in a process of generating the low-precision information map level by level based on the depth information map, to obtain the target information map, a depth value required to be stored in the pixel in the (k+1)^{th}-level information map may be generated each time based on a depth value stored in an adjacent pixel in the k^{th}-level of information map. In this way, depth values stored in information maps of two adjacent levels vary smoothly, improving smoothness between the information maps. In addition, a depth value stored in the finally generated target information map includes related information of each depth value originally stored in the depth information map, so that when each invalid pixel in the depth information map is subsequently filled based on the target information map, a depth value filling each invalid pixel may include related information of an originally existing depth value, improving quality of the reconstructed depth information map.

s12: Fill an invalid pixel in a high-precision information map level by level based on the target information map, until each invalid pixel in the depth information map is filled, to obtain the reconstructed depth information map.

During level-by-level filling of the invalid pixel in the high-precision information map, a depth value stored in an invalid pixel in the k^{th}-level information map is determined based on a depth value stored in a (k+1) th level. The (k+1)^{th}-level information map is the target information map when the value of k is k−1. Filling the invalid pixel in the high-precision information map level by level based on the target information map means according to a principle of filling information maps from low to high precision, first filling an invalid pixel in an adjacent high-precision information map (that is, a (K−1)^{th}-level information map) based on the target information map (that is, a K^{th}-level information map), then filling an invalid pixel in an adjacent high-precision information map (that is, a (K−2)^{th}-level information map) based on the (K−1)^{th}-level information map, then filling an invalid pixel in an adjacent high-precision information map (that is, a (K−3)^{th}-level information map) based on the (K−2)^{th}-level information map, and so on, until the invalid pixel in the depth information map (that is, the zeroth-level information map) is filled. In other words, during specific implementation of operation s12, the value of k decreases stepwise. To be specific, k is first valued to K−1, then K−2, and so on, until the value of k is 0.

According to an aspect of operation s12, the computer device may traverse the invalid pixel in the k^{th}-level information map, and maps a currently traversed invalid pixel to the (k+1)^{th}_level information map, to obtain a mapping point. After the mapping point is obtained, the computer device may select at least one pixel from the (k+1)^{th}-information map based on the mapping point as a reference pixel of the currently traversed invalid pixel. A pixel selection manner is not limited in an aspect. For example, at least one pixel may be selected on each of left and right sides of the mapping point, or a plurality of pixels may be selected only on a left side or a right side of the mapping point. Then, a depth value in the currently traversed invalid pixel may be calculated based on a depth value stored in each reference pixel, and the currently traversed invalid pixel is filled with the calculated depth value. Then, traversing may be continued until each invalid pixel in the k^{th}-level information map is traversed. If there is no invalid pixel in the k^{th}-level information map, one may be subtracted from the value of k to update k, to perform again the operation of traversing the invalid pixel in the k^{th}-level information map. For example, if the value of k is 3, there is no invalid pixel in a third-level information map, and one may be subtracted to update the value of k to 2, to traverse the invalid pixel in the second-level information map. Further, if there is no invalid pixel in the second-level information map, one may be subtracted to update the value of k to 1 again, to traverse the invalid pixel in the first-level information map, and so on.

Additionally or alternatively, when mapping the currently traversed invalid pixel to the (k+1)^{th}-level information map, the mapping point may be obtained by: obtaining a horizontal coordinate and a vertical coordinate of the currently traversed invalid pixel in the k^{th}-level information map, calculating a ratio of the horizontal coordinate to an image width (e.g., horizontal length, or length of x-coordinate) of the k^{th}-level information map to be used as a horizontal scaling parameter, and calculating a ratio of the vertical coordinate to an image height (e.g., vertical length, or length of y-coordinate) of the k^{th}-level information map to be used as a vertical scaling parameter. Then, the computer device multiplies the horizontal scaling parameter by the image length of the (k+1)^{th}-level information map to obtain a horizontal coordinate of the mapping point, and performing a similar process to obtain the vertical coordinate of the mapping point (i.e., multiplying the vertical scaling parameter by an image height of the (k+1)^{th}-level information map). For example, when the horizontal coordinate of the currently traversed invalid pixel in the k^{th}-level information map is 10, the vertical coordinate is 6, the image width of the k^{th}-level information map is 100, and the image height is 60. Then, the horizontal scaling parameter may be calculated as 10/100=0.1, and the vertical scaling parameter as 6/60=0.1. If the image width of the (k+1)^{th}-level of the information map is 60 and the image height is 40, it may be obtained through calculation that the horizontal coordinate of the mapping point is 0.1×60=6 and the vertical coordinate of the mapping point is 0.1×40=4. Therefore, it may be determined that a point whose coordinates are (6, 4) in the (k+1)^{th}-level information map is a mapping point of the currently traversed invalid pixel in the (k+1)^{th}-level information map.

According to another aspect, the depth value of the currently traversed invalid pixel may be calculated based on the depth value stored in each reference pixel. In this aspect, the computer device allocates a weight to each reference pixel based on a distance between each reference pixel and the mapping point, wherein a distance is inversely proportional to a weight and a sum of the weights of the reference pixels is equal to 1. The computer device may then perform validity checks on each reference pixel, such as determining whether each reference pixel stores a depth value. If a reference pixel stores a depth value, validity check on the reference pixel succeeds. Then, weighted averaging may be performed, based on a weight and depth value of a valid reference pixel, to obtain the depth value in the currently traversed invalid pixel. In this manner, a depth value in an invalid pixel may be further based on a depth value stored in a reference pixel closer to the invalid pixel, ensuring a smooth transition between the calculated depth value in the invalid pixel and the depth value in the reference pixel and further improving accuracy of the depth value in the invalid pixel. Additionally or alternatively, the depth value of the invalid pixel may be determined by averaging the depth value stored in each reference pixel, to obtain the depth value in the currently traversed invalid pixel. Additionally or alternatively, the depth value of the invalid pixel may also be determined by validating each reference pixel, then allocating, based on a distance between each valid reference pixel the mapping point and according to a principle that a distance is inversely proportional to a weight, a weight to each valid reference pixel, and calculating a weighted average on the weight and the corresponding depth value of the valid reference pixels to obtain the depth value in the currently traversed invalid pixel. Other methods may also be possible.

For example, as shown in the left figure in FIG. 5i, the target information map is the second-level information map shown in the left figure in FIG. 5h. First, it may be detected whether there is an invalid pixel in the first-level information map. Because there is no invalid pixel in the first-level information map, the computer device may continue to detect whether there is an invalid pixel in the zeroth-level information map (that is, the depth information map). It can be learned from the foregoing descriptions that the zeroth-level information map includes a large quantity of invalid pixels. Therefore, the computer device may traverse each invalid pixel, and select four pixels from the first-level information map as reference pixels of a currently traversed invalid pixel.

According to distances between the four reference pixels and the currently traversed invalid pixel, a weight ratio of the four reference pixels may be 1:3:3:9, that is, weights of the four reference pixels may be 1/16, 3/16, 3/16, and 9/16. Then, the four reference pixels may be screened. Because the four reference pixels are all valid, weighted averaging may be performed on depth values stored in the four reference pixels based on the weights of the four reference pixels, and a mean value obtained through weighted averaging is specified as a depth value and stored in the currently traversed invalid pixel, as shown in the right figure in FIG. 5i. A dashed-line dot in the right figure in FIG. 5i indicates a pixel in the zeroth-level information map, and a solid-line dot indicates a pixel in the first-level information map. Then, another invalid pixel in the zeroth-level information map (that is, the depth information map) may continue to be traversed, until each invalid pixel is traversed, to obtain the reconstructed depth information map.

According to an aspect, while filling the high-precision information map level by level based on the target information map and to obtain the reconstructed depth information map, the invalid pixel in the k^{th}-level information map may be filled each time based on a depth value stored in at least one pixel in the (k+1)^{th}-level information map. In this way, depth values stored in information maps of two adjacent levels vary smoothly, improving smoothness between the information maps.

Based on the foregoing related descriptions of s11 to s12, according to another aspect, the low-precision information map is first generated level by level based on the depth information map, to obtain the target information map, and then the invalid pixel in the high-precision information map is filled level by level based on the target information map, to reconstruct the depth information map. In this way, a smooth transition can be ensured between depth values stored in adjacent pixels in the reconstructed depth information map, improving image quality of the reconstructed depth information map.

The foregoing describes an implementation of the information reconstruction policy only for illustrative purposes. For example, when the shape of the surface element is a circle, the information reconstruction policy may be a policy of performing information reconstruction based on a radius of the surface element. Based on this, a specific implementation in which the computer device performs information reconstruction on the invalid pixel in the depth information map based on the information reconstruction policy, to obtain the reconstructed depth information map may be: traversing each surface element, and performing scaling processing on a radius of a currently traversed surface element based on a preset radius scaling ratio, to obtain a scaled radius; drawing a circular region at the scaled radius based on a projection point of the currently traversed surface element in the depth information map, and filling, with a depth value of the current surface element in the virtual scene, a depth value of each invalid pixel in the depth information map that is located in the drawn circular region; and continuing traversing until each surface element is traversed, to obtain the reconstructed depth information map.

In an aspect, the plurality of surface elements are generated in the virtual scene. The distance value between each surface element and the camera is obtained as the depth value of the corresponding surface element in the virtual scene, so that the full-viewing-angle depth information of the virtual scene is constructed by using the depth value of each surface element in the virtual scene. A full-viewing-angle depth information construction procedure provided in an aspect is simple, so that time costs and processing resources (for example, a bandwidth) that are required for constructing the full-viewing-angle depth information can be reduced, and efficiency of constructing the full-viewing-angle depth information can be improved. In addition, because each surface element is attached to a surface of a corresponding virtual object, the depth value of each surface element in the virtual scene can accurately represent a depth value of the corresponding virtual object. Therefore, constructing the full-viewing-angle depth information by using the depth value of each surface element can ensure high accuracy of the constructed full-viewing-angle depth information, and improve quality of the full-viewing-angle depth information. Moreover, when a plurality of surface elements are attached to a surface of each virtual object, a depth value of the same virtual object may be jointly represented by depth values of the plurality of surface elements in the full-viewing-angle depth information. This can further improve accuracy of the depth value of the virtual object, thereby further improving the quality of the full-viewing-angle depth information.

In an actual application, the full-viewing-angle depth information construction methods shown in FIG. 2 and FIG. 4 may be applied to various virtual scenes, such as a game scene, a scene of a television drama, and a digital simulation scene (that is, a scene obtained by performing digital simulation on a scene in a real world). For example, the virtual scene is the game scene. An application process of the full-viewing-angle depth information construction method may include the following two parts.

The first part is representation of geometrical information of the scene based on a surface element. This part is mainly to generate a plurality of surface elements in the game scene in a manner of making the surface elements cling to a grid body surface of each virtual object (for example, a virtual character, a virtual prop, and a virtual scenery) in the game scene, to establish a surface element-based scene representation system and further approximately represent the geometrical information of the game scene by using these surface elements.

The second part is construction of depth information of the scene based on the surface element. In this part, a direction vector between a center point of each surface element and a camera may be first calculated based on world space coordinates of the center point of each surface element and world space coordinates of the camera. Then, the center point of each surface element may be projected to a two-dimensional mapping template through an octahedral mapping operation based on each calculated direction vector, to obtain a plurality of first projection points. One first projection point is used for indicating a projection position of a center point of one surface element in the mapping template. Then, a pixel in the mapping template that is located at each first projection point may be used as a pixels in the mapping template that corresponds to a corresponding surface element, and a depth value of each surface element in the game scene is stored in the corresponding pixel, to obtain a depth information map. Further, information reconstruction may be performed on an invalid pixel in the depth information map by using the foregoing pull-push policy, and a reconstructed depth information map is used as full-viewing-angle depth information of the game scene. Aspects provided herein provide for, after a full-viewing-angle depth information map of the game scene is obtained, ray tracing may be further performed based on the full-viewing-angle depth information, to render a corresponding game picture based on a ray tracing result.

In an aspect, the full-viewing-angle depth information of the game scene is obtained by first constructing the surface elements and then performing pull-push restoration. In this way, on the one hand, quality of the full-viewing-angle depth information can be improved. When the full-viewing-angle depth information is used for ray tracing, quality of the full-viewing-angle depth information can satisfy use of a subsequent ray tracing procedure, so that the game picture can present more real illumination effects when the game picture is subsequently rendered based on the ray tracing result. On the other hand, compared with a drawing manner in a conventional scene in which a plurality of depth tests are required for each virtual object, a bandwidth and time required for drawing and submission can be greatly reduced, improving efficiency of constructing the full-viewing-angle depth information to some extent, and greatly improving quality indicators such as running efficiency and bandwidth consumption in a game.

Similarly, when the virtual scene is a scene obtained by performing digital simulation on a popular scenic spot in the real world (a digital simulation scene for short), an application process of the full-viewing-angle depth information construction method may include the following two parts.

The first part is representation of geometrical information of the scene based on a surface element. This part is mainly to generate a plurality of surface elements in the digital simulation scene in a manner of making the surface elements cling to a grid body surface of each virtual object (for example, a virtual building obtained by performing digital simulation on a building in the popular scenic spot and a virtual plant obtained by performing digital simulation on a plant in the popular scenic spot) in the digital simulation scene, to establish a surface element-based scene representation system and further approximately represent the geometrical information of the digital simulation scene by using these surface elements.

The second part is construction of full-viewing-angle depth information of the scene based on the surface element. In this part, a center point of each surface element may be first projected onto a two-dimensional mapping template through an octahedral mapping operation based on a direction vector between the center point of each surface element and a camera, to obtain a plurality of first projection points. A pixel in the mapping template that is located at each first projection point is used as a pixel in the mapping template that corresponds to a corresponding surface element. A depth value of each surface element in the digital simulation scene is stored in a corresponding pixel, to obtain a depth information map. Further, information reconstruction may be performed on an invalid pixel in the depth information map by using the foregoing pull-push policy, and a reconstructed depth information map is used as full-viewing-angle depth information of the digital simulation scene. According to an aspect, after a full-viewing-angle depth information map of the digital simulation scene is obtained, ray tracing may be further performed based on the full-viewing-angle depth information, to render a corresponding digital simulation picture based on a ray tracing result.

In an aspect, the full-viewing-angle depth information of the digital simulation scene is obtained by first constructing the surface elements and then performing pull-push restoration. In this way, on the one hand, quality of the full-viewing-angle depth information can be improved. When the full-viewing-angle depth information is used for ray tracing, quality of the full-viewing-angle depth information can satisfy use of a subsequent ray tracing procedure, so that the rendered digital simulation picture can present more real illumination effects when the digital simulation picture is subsequently rendered based on the ray tracing result. On the other hand, compared with a drawing manner in a conventional scene in which a plurality of depth tests are required for each virtual object, a bandwidth and time required for drawing and submission can be greatly reduced, improving efficiency of constructing the full-viewing-angle depth information to some extent, avoiding non-fluency during rendering and displaying of the digital simulation picture, and improving displaying fluency of the digital simulation picture.

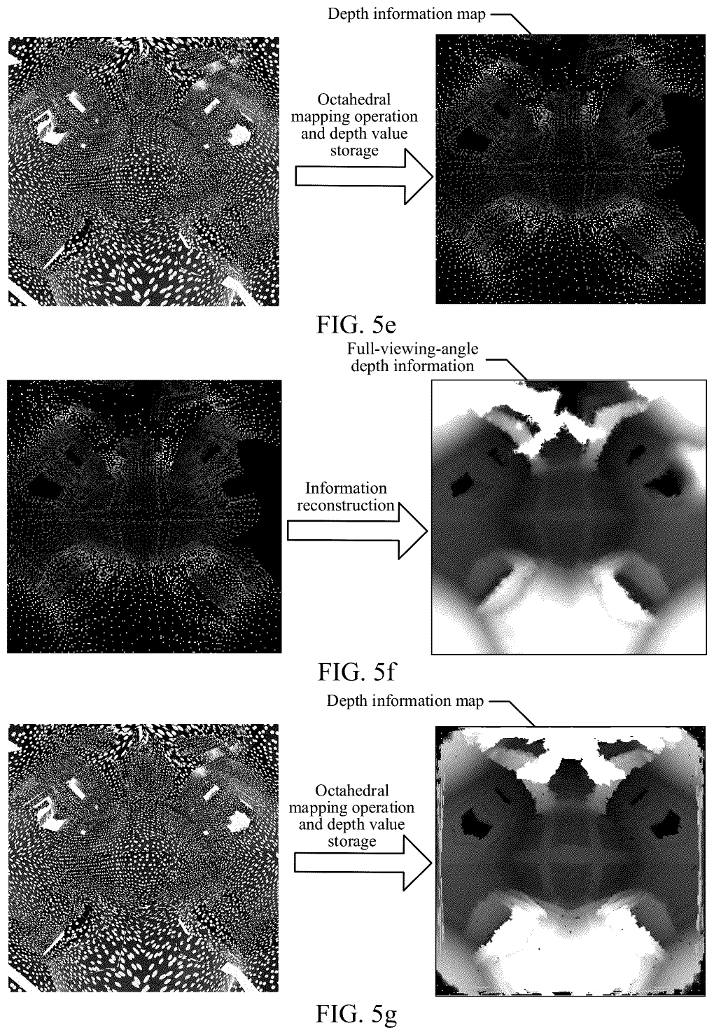

Based the full-viewing-angle depth information construction method, aspects described herein further disclose a full-viewing-angle depth information construction apparatus. The full-viewing-angle depth information construction apparatus may be a computer program (including program code) run on a computer device. The full-viewing-angle depth information construction apparatus may perform the operations in the method procedure shown in FIG. 2 or FIG. 4. Refer to FIG. 6. The full-viewing-angle depth information construction apparatus may run the following units:
a processing unit 601, configured to obtain a virtual scene, the virtual scene including a camera and at least one virtual object, and the camera being a component configured to present a view of the virtual scene in a direction of at least one viewing angle;
the processing unit 601 being further configured to generate a plurality of surface elements in the virtual scene, the surface element being a plane figure having a direction and a size, and at least one surface element being attached to a surface of each virtual object;
the processing unit 601 being further configured to obtain a depth value of each of the plurality of surface elements in the virtual scene, the depth value being a distance value between the surface element and the camera; and
a construction unit 602, configured to construct full-viewing-angle depth information of the virtual scene by using the obtained depth values.

In an implementation, when configured to construct the full-viewing-angle depth information of the virtual scene by using the obtained depth values, the construction unit 602 may be specifically configured to:
obtain a mapping template, the mapping template including a plurality of pixels, and one pixel being used for storing one depth value;
project the plurality of surface elements from the virtual scene to the mapping template, to obtain a pixel in the mapping template that corresponds to each of the plurality of surface elements; and
store, in the pixel in the mapping template that corresponds to each of the plurality of surface elements, the obtained depth value of each of the plurality of surface elements in the virtual scene, to obtain the full-viewing-angle depth information of the virtual scene.

In another implementation, when configured to project the plurality of surface elements from the virtual scene to the mapping template, to obtain the pixel in the mapping template that corresponds to each of the plurality of surface elements, the construction unit 602 may be specifically configured to:
project, for an i^{th} surface element based on a direction vector between a center point of the i^{th} surface element and the camera, the corresponding center point from the virtual scene to the mapping template, to obtain a first projection point, i∈[1, I], and I being a total quantity of the surface elements; and
use a pixel in the mapping template that is located at the first projection point as a pixel in the mapping template that corresponds to the i^{th} surface element.

In another implementation, when configured to store, in the pixel in the mapping template that corresponds to each of the plurality of surface elements, the obtained depth value of each of the plurality of surface elements in the virtual scene, to obtain the full-viewing-angle depth information of the virtual scene, the construction unit 602 may be specifically configured to:
store, in the pixel in the mapping template that corresponds to each of the plurality of surface elements, the obtained depth value of each of the plurality of surface elements in the virtual scene, to obtain a depth information map, a pixel in the depth information map that does not store a depth value of any surface element being an invalid pixel; and
perform information reconstruction on the invalid pixel in the depth information map based on an information reconstruction policy, to obtain a reconstructed depth information map, and use the reconstructed depth information map as the full-viewing-angle depth information of the virtual scene.

In another implementation, when configured to perform information reconstruction on the invalid pixel in the depth information map based on the information reconstruction policy, to obtain the reconstructed depth information map, the construction unit 602 may be specifically configured to:
generate a low-precision information map level by level based on the depth information map, to obtain a target information map, the target information map including only one pixel, a depth value being stored in the included pixel, and during level-by-level generation of the low-precision information map, a depth value stored in any pixel in a (k+1) th-level information map being determined based on depth values stored in a plurality of pixels in a k^{th}-level information map; and
fill an invalid pixel in a high-precision information map level by level based on the target information map, until each invalid pixel in the depth information map is filled, to obtain the reconstructed depth information map, during level-by-level filling of the invalid pixel in the high-precision information map, a depth value stored in an invalid pixel in the k^{th}-level information map being determined based on a depth value stored in at least one pixel in the (k+1)^{th}-level information map,
precision of any information map being in positive correlation with a quantity of pixels included in the corresponding information map, k∈[1, K−1], K being a precision level corresponding to the target information map, a zeroth-level information map being the depth information map, and the (k+1)^{th}-level information map being the target information map when a value of k is k−1.

In another implementation, when configured to generate the low-precision information map level by level based on the depth information map, the construction unit 602 may be specifically configured to:
group a pixel in the k^{th}-level information map, and determine, based on a grouping result, an image template used for generating the (k+1)^{th}-level information map, no pixel in the image template storing a depth value, one pixel in the image template corresponding to one pixel group in the grouping result, and different pixels corresponding to different pixel groups; traverse each pixel in the image template, and use a currently traversed pixel as a current pixel;
obtain a pixel group corresponding to the current pixel from the grouping result, and select a valid pixel from the obtained pixel group, the valid pixel being a pixel storing a depth value;
perform, if at least one valid pixel is selected, a mean operation on a depth value stored in each selected valid pixel, use a value obtained through the mean operation as a depth value, and store the depth value in the current pixel; or determine that the current pixel is empty if no valid pixel is selected; and continue traversing until each pixel in the image template is traversed, to obtain the (k+1)^{th}-level information map.

In another implementation, when configured to fill the invalid pixel in a high-precision information map level by level based on the target information map, the construction unit 602 may be specifically configured to:
traverse the invalid pixel in the k^{th}-level information map;
map a currently traversed invalid pixel to the (k+1)^{th}-level information map, to obtain a mapping point, and select at least one pixel from the (k+1)^{th}-level information map based on the mapping point as a reference pixel of the currently traversed invalid pixel;
calculate a depth value in the currently traversed invalid pixel based on a depth value stored in each reference pixel, and fill the currently traversed invalid pixel with the calculated depth value; and
continue traversing until each invalid pixel in the k^{th}-level information map is traversed.

In another implementation, when configured to calculate the depth value in the currently traversed invalid pixel based on the depth value stored in each reference pixel, the construction unit 602 may be specifically configured to:
allocate a weight to each reference pixel based on a distance between each reference pixel and the mapping point and according to a principle that a distance is inversely proportional to a weight;
perform validity check on each reference pixel, validity check on a reference pixel succeeding if the reference pixel stores a depth value; and
perform, based on a weight of a valid reference pixel, weighted averaging on a depth value stored in the corresponding reference pixel, to obtain the depth value in the currently traversed invalid pixel.

In another implementation, a shape of any surface element is a circle. Correspondingly, when configured to project the plurality of surface elements from the virtual scene to the mapping template, to obtain the pixel in the mapping template that corresponds to each of the plurality of surface elements, the construction unit 602 may be specifically configured to:
project, for the i^{th} surface element based on the direction vector between the center point of the i^{th} surface element and the camera, the corresponding center point from the virtual scene to the mapping template, to obtain the first projection point, i∈[1, I], and I being the total quantity of the surface elements;
project, based on a direction vector between an edge point of the i^{th} surface element and the camera, the corresponding edge point from the virtual scene to the mapping template, to obtain a second projection point, the edge point being a point selected from an edge of the i^{th} surface element based on a radius of the i^{th} surface element;
draw a circle on the mapping template by using the first projection point as a circle center and a distance between the first projection point and the second projection point as a radius, to obtain a circular region; and
use each pixel in the mapping template that is located in the circular region as a pixel in the mapping template that corresponds to the i^{th} surface element.

In another implementation, the construction unit 602 may be further configured to: obtain surface element information of the i^{th} surface element, the surface element information including the radius, world space coordinates of the center point, and a normal vector of the i^{th} surface element; and
determine the edge of the i^{th} surface element in the virtual scene based on the obtained surface element information, and select a point from the determined edge as the edge point of the i^{th} surface element.

In another implementation, when configured to project the plurality of surface elements from the virtual scene to the mapping template, to obtain the pixel in the mapping template that corresponds to each of the plurality of surface elements, the construction unit 602 may be specifically configured to:
select, for the i^{th} surface element, K edge points from the edge of the i^{th} surface element, K being an integer greater than 2, i∈[1, I], and I being the total quantity of the surface elements;
project, based on a direction vector between each edge point and the camera, the corresponding edge point from the virtual scene to the mapping template, to obtain K second projection points;
connect in sequence the K second projection points on the mapping template, to obtain a closed region; and
use each pixel in the mapping template that is located in the closed region as a pixel in the mapping template that corresponds to the i^{th} surface element.

In another implementation, when configured to store, in the pixel in the mapping template that corresponds to each of the plurality of surface elements, the obtained depth value of each of the plurality of surface elements in the virtual scene, to obtain the full-viewing-angle depth information of the virtual scene, the construction unit 602 may be specifically configured to:
store, in the pixel in the mapping template that corresponds to each of the plurality of surface elements, the obtained depth value of each of the plurality of surface elements in the virtual scene, to obtain the depth information map; and
use the depth information map as the full-viewing-angle depth information of the virtual scene.

According to another aspect, the units in the full-viewing-angle depth information construction apparatuses shown in FIG. 6 may exist separately or be combined into one or more other units. Alternatively, a specific (or some) unit among the units may be further split into a plurality of smaller function units, to implement the same operations. The foregoing units are obtained through division based on logical functions. In an actual application, a function of one unit may be implemented by a plurality of units, or functions of a plurality of units may be implemented by one unit. According to another aspects, the full-viewing-angle depth information construction apparatus may include other units. In an actual application, these functions may be implemented collaboratively by the other units, and may be implemented collaboratively by a plurality of units.

According to aspects described herein, a computer program (including program code) capable of performing each operation in the corresponding method shown in FIG. 2 or FIG. 4 may be run in a general-purpose computing device, for example, a computer, including a processing element and a storage element, for example, a central processing unit (CPU), a random access memory (RAM), or a read-only memory (ROM), to structure the full-viewing-angle depth information construction apparatus shown in FIG. 6 and implement the full-viewing-angle depth information construction method according to aspects described herein. The computer program may be recorded in, for example, a computer-readable recording medium, and may be loaded into the computing device via the computer-readable recording medium and run in the computing device.

In an aspect, the plurality of surface elements are generated in the virtual scene, and the distance value between each surface element and the camera is obtained as the depth value of the corresponding surface element in the virtual scene, so that the full-viewing-angle depth information of the virtual scene is constructed by using the depth value of each surface element in the virtual scene. A full-viewing-angle depth information construction procedure provided in an aspect is simple, so that time costs and processing resources (for example, a bandwidth) that are required for constructing the full-viewing-angle depth information can be reduced, and efficiency of constructing the full-viewing-angle depth information can be improved. In addition, because each surface element is attached to a surface of a corresponding virtual object, the depth value of each surface element in the virtual scene can accurately represent a depth value of the corresponding virtual object. Therefore, constructing the full-viewing-angle depth information by using the depth value of each surface element can ensure high accuracy of the constructed full-viewing-angle depth information, and improve quality of the full-viewing-angle depth information. Moreover, when a plurality of surface elements are attached to a surface of each virtual object, a depth value of the same virtual object may be jointly represented by depth values of the plurality of surface elements in the full-viewing-angle depth information. This can further improve accuracy of the depth value of the virtual object, thereby further improving the quality of the full-viewing-angle depth information.

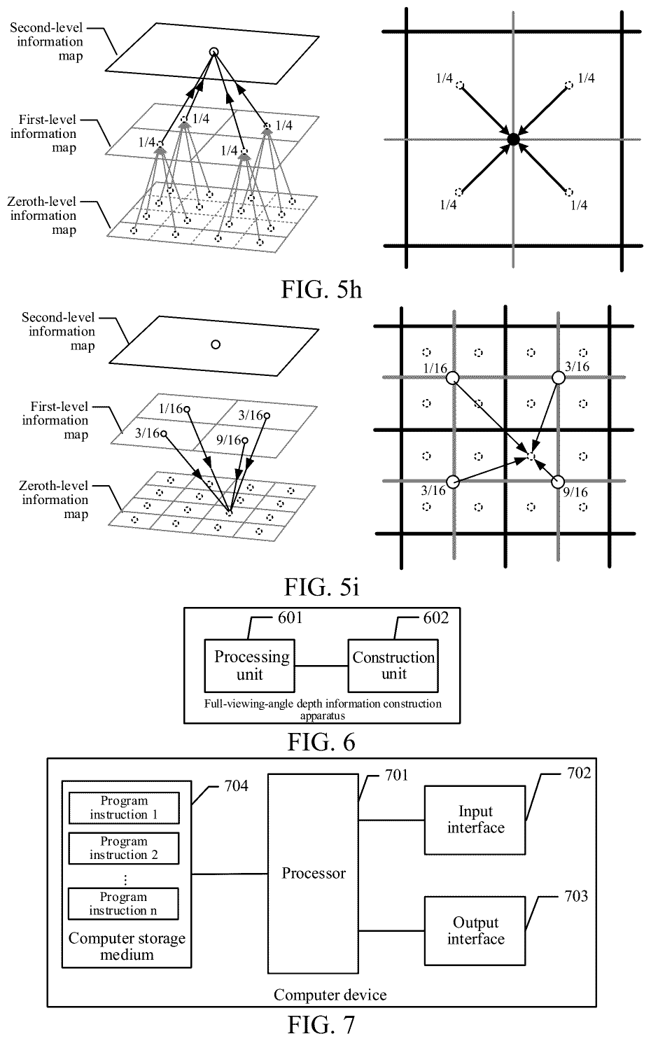

Aspects described herein may further provide for a computer device, as illustrated in FIG. 7. The computer device includes at least a processor 701, an input interface 702, an output interface 703, and a computer storage medium 704. The processor 701, the input interface 702, the output interface 703, and the computer storage medium 704 in the computer device may be connected through a bus or in another manner. The computer storage medium 704 may be stored in a memory of the computer device. The computer storage medium 704 is configured to store a computer program. The computer program includes program instructions. The processor 701 is configured to execute the program instructions stored in the computer storage medium 704. As a computing core and a control core of the computer device, the processor 701 (or referred to as a CPU) is adapted to implementing one or more instructions, specifically adapted to loading and executing the one or more instructions, to implement corresponding method procedures or corresponding functions.

According to an aspect, the processor 701 may be configured to perform a series of full-viewing-angle depth information construction processing on a virtual scene, specifically including: generating a plurality of surface elements in the virtual scene, the surface element being a plane figure having a direction and a size, the virtual scene including a camera and at least one virtual object, and at least one surface element being attached to a surface of each virtual object; obtaining a depth value of each generated surface element in the virtual scene, a depth value of any surface element in the virtual scene being determined by a distance value between the corresponding surface element and the camera; constructing full-viewing-angle depth information of the virtual scene by using the depth value of each surface element in the virtual scene; and the like.

Aspects described herein further provide for a computer storage medium (memory). As a memory device in a computer device, the computer storage medium is configured to store a program and data. The computer storage medium herein may include a built-in storage medium of the computer device, or may definitely include an extended storage medium supported by the computer device. The computer storage medium provides storage space storing an operating system of the computer device. In addition, one or more instructions adapted to being loaded and executed by the processor 701 are also stored in the storage space, and these instructions may be one or more computer programs (including program code). The computer storage medium herein may be a high-speed RAM, or a non-volatile memory, for example, at least one disk memory. According to an aspect, the computer storage medium may be at least one computer storage medium that is far away from the foregoing processor.

The processor may load and execute the one or more instructions stored in the computer storage medium, to implement corresponding operations according to aspects illustrated in FIG. 2 or FIG. 4. In specific implementation, the one or more instructions in the computer storage medium may be loaded by the processor to perform the following operations:
obtaining a virtual scene, the virtual scene including a camera and at least one virtual object, and the camera being a component configured to present a view of the virtual scene in a direction of at least one viewing angle;
generating a plurality of surface elements in the virtual scene, the surface element being a plane figure having a direction and a size, and at least one surface element being attached to a surface of each virtual object;
obtaining a depth value of each of the plurality of surface elements in the virtual scene, the depth value being a distance value between the surface element and the camera; and
constructing full-viewing-angle depth information of the virtual scene by using the obtained depth values.

In an implementation, when the full-viewing-angle depth information of the virtual scene is constructed by using the obtained depth values, the one or more instructions may be loaded by the processor to specifically perform the following operations:
obtaining a mapping template, the mapping template including a plurality of pixels, and one pixel being used for storing one depth value;
projecting the plurality of surface elements from the virtual scene to the mapping template, to obtain a pixel in the mapping template that corresponds to each of the plurality of surface elements; and
storing, in the pixel in the mapping template that corresponds to each of the plurality of surface elements, the obtained depth value of each of the plurality of surface elements in the virtual scene, to obtain the full-viewing-angle depth information of the virtual scene.

In another implementation, when the plurality of surface elements are projected from the virtual scene to the mapping template, to obtain the pixel in the mapping template that corresponds to each of the plurality of surface elements, the one or more instructions may be loaded by the processor to specifically perform the following operations:
projecting, for an i^{th} surface element based on a direction vector between a center point of the i^{th} surface element and the camera, the corresponding center point from the virtual scene to the mapping template, to obtain a first projection point, i∈[1, I], and I being a total quantity of the surface elements; and
using a pixel in the mapping template that is located at the first projection point as a pixel in the mapping template that corresponds to the i^{th} surface element.

In another implementation, when the obtained depth value of each of the plurality of surface elements in the virtual scene is stored in the pixel in the mapping template that corresponds to each of the plurality of surface elements, to obtain the full-viewing-angle depth information of the virtual scene, the one or more instructions may be loaded by the processor to specifically perform the following operations:
storing, in the pixel in the mapping template that corresponds to each of the plurality of surface elements, the obtained depth value of each of the plurality of surface elements in the virtual scene, to obtain a depth information map, a pixel in the depth information map that does not store a depth value of any surface element being an invalid pixel; and
performing information reconstruction on the invalid pixel in the depth information map based on an information reconstruction policy, to obtain a reconstructed depth information map, and using the reconstructed depth information map as the full-viewing-angle depth information of the virtual scene.

In another implementation, when information reconstruction is performed on the invalid pixel in the depth information map based on the information reconstruction policy, to obtain the reconstructed depth information map, the one or more instructions may be loaded by the processor to specifically perform the following operations:
generating a low-precision information map level by level based on the depth information map, to obtain a target information map, the target information map including only one pixel, a depth value being stored in the included pixel, and during level-by-level generation of the low-precision information map, a depth value stored in any pixel in a (k+1)^{th}-level information map being determined based on depth values stored in a plurality of pixels in a k^{th}-level information map; and
filling an invalid pixel in a high-precision information map level by level based on the target information map, until each invalid pixel in the depth information map is filled, to obtain the reconstructed depth information map, during level-by-level filling of the invalid pixel in the high-precision information map, a depth value stored in an invalid pixel in the k^{th}-level information map being determined based on a depth value stored in at least one pixel in the (k+1)^{th}-level information map,
precision of any information map being in positive correlation with a quantity of pixels included in the corresponding information map, k∈[1, K−1], K being a precision level corresponding to the target information map, a zeroth-level information map being the depth information map, and the (k+1)^{th}-level information map being the target information map when a value of k is k−1.

In another implementation, when the low-precision information map is generated level by level based on the depth information map, the one or more instructions may be loaded by the processor to specifically perform the following operations:
grouping a pixel in the k^{th}-level information map, and determining, based on a grouping result, an image template used for generating the (k+1)^{th}-level information map, no pixel in the image template storing a depth value, one pixel in the image template corresponding to one pixel group in the grouping result, and different pixels corresponding to different pixel groups;
traversing each pixel in the image template, and using a currently traversed pixel as a current pixel;
obtaining a pixel group corresponding to the current pixel from the grouping result, and selecting a valid pixel from the obtained pixel group, the valid pixel being a pixel storing a depth value;
performing, if at least one valid pixel is selected, a mean operation on a depth value stored in each selected valid pixel, using a value obtained through the mean operation as a depth value, and storing the depth value in the current pixel; or determining that the current pixel is empty if no valid pixel is selected; and
continuing traversing until each pixel in the image template is traversed, to obtain the (k+1)^{th}-level information map.

In another implementation, when the invalid pixel in the high-precision information map is filled level by level based on the target information map, the one or more instructions may be loaded by the processor to specifically perform the following operations:
traversing the invalid pixel in the k^{th}-level information map;
mapping a currently traversed invalid pixel to the (k+1)^{th}-level information map, to obtain a mapping point, and selecting at least one pixel from the (k+1)^{th}-level information map based on the mapping point as a reference pixel of the currently traversed invalid pixel;
calculating a depth value in the currently traversed invalid pixel based on a depth value stored in each reference pixel, and filling the currently traversed invalid pixel with the calculated depth value; and
continuing traversing until each invalid pixel in the k^{th}-level information map is traversed.

In another implementation, when the depth value in the currently traversed invalid pixel is calculated based on the depth value stored in each reference pixel, the one or more instructions may be loaded by the processor to specifically perform the following operations:
allocating a weight to each reference pixel based on a distance between each reference pixel and the mapping point and according to a principle that a distance is inversely proportional to a weight;
performing validity check on each reference pixel, validity check on a reference pixel succeeding if the reference pixel stores a depth value; and
performing, based on a weight of a valid reference pixel, weighted averaging on a depth value stored in the corresponding reference pixel, to obtain the depth value in the currently traversed invalid pixel.

In another implementation, a shape of any surface element is a circle. Correspondingly, when the plurality of surface elements are projected from the virtual scene to the mapping template, to obtain the pixel in the mapping template that corresponds to each of the plurality of surface elements, the one or more instructions may be loaded by the processor to specifically perform the following operations:
projecting, for the i^{th} surface element based on the direction vector between the center point of the i^{th} surface element and the camera, the corresponding center point from the virtual scene to the mapping template, to obtain the first projection point, i∈[1, I], and I being the total quantity of the surface elements;
projecting, based on a direction vector between an edge point of the i^{th} surface element and the camera, the corresponding edge point from the virtual scene to the mapping template, to obtain a second projection point, the edge point being a point selected from an edge of the i^{th} surface element based on a radius of the i^{th} surface element;
drawing a circle on the mapping template by using the first projection point as a circle center and a distance between the first projection point and the second projection point as a
using each pixel in the mapping template that is located in the circular region as a pixel in the mapping template that corresponds to the i^{th} surface element.

In another implementation, the one or more instructions may be loaded by the processor to specifically perform the following operations:
obtaining surface element information of the i^{th} surface element, the surface element information including the radius, world space coordinates of the center point, and a normal vector of the i^{th} surface element; and
determining the edge of the i^{th} surface element in the virtual scene based on the obtained surface element information, and selecting a point from the determined edge as the edge point of the i^{th} surface element.

In another implementation, when the plurality of surface elements are projected from the virtual scene to the mapping template, to obtain the pixel in the mapping template that corresponds to each of the plurality of surface elements, the one or more instructions may be loaded by the processor to specifically perform the following operations:

selecting, for the i^{th} surface element, K edge points from the edge of the i^{th} surface element, K being an integer greater than 2, i∈[1, I], and I being the total quantity of the surface elements;
projecting, based on a direction vector between each edge point and the camera, the corresponding edge point from the virtual scene to the mapping template, to obtain K second projection points;
connecting in sequence the K second projection points on the mapping template, to obtain a closed region; and
using each pixel in the mapping template that is located in the closed region as a pixel in the mapping template that corresponds to the i^{th} surface element.

In another implementation, when the obtained depth value of each of the plurality of surface elements in the virtual scene is stored in the pixel in the mapping template that corresponds to each of the plurality of surface elements, to obtain the full-viewing-angle depth information of the virtual scene, the one or more instructions may be loaded by the processor to specifically perform the following operations:
storing, in the pixel in the mapping template that corresponds to each of the plurality of surface elements, the obtained depth value of each of the plurality of surface elements in the virtual scene, to obtain the depth information map; and
using the depth information map as the full-viewing-angle depth information of the virtual scene.

In an aspect, the plurality of surface elements are generated in the virtual scene, and the distance value between each surface element and the camera is obtained as the depth value of the corresponding surface element in the virtual scene, so that the full-viewing-angle depth information of the virtual scene is constructed by using the depth value of each surface element in the virtual scene. A full-viewing-angle depth information construction procedure provided in an aspect is simple, so that time costs and processing resources (for example, a bandwidth) that are required for constructing the full-viewing-angle depth information can be reduced, and efficiency of constructing the full-viewing-angle depth information can be improved. In addition, because each surface element is attached to a surface of a corresponding virtual object, the depth value of each surface element in the virtual scene can accurately represent a depth value of the corresponding virtual object. Therefore, constructing the full-viewing-angle depth information by using the depth value of each surface element can ensure high accuracy of the constructed full-viewing-angle depth information, and improve quality of the full-viewing-angle depth information. Moreover, when a plurality of surface elements are attached to a surface of each virtual object, a depth value of the same virtual object may be jointly represented by depth values of the plurality of surface elements in the full-viewing-angle depth information. This can further improve accuracy of the depth value of the virtual object, thereby further improving the quality of the full-viewing-angle depth information.

According to an aspect of this application, a computer program product or a computer program is further provided. The computer program product or the computer program includes computer instructions. The computer instructions are stored in a computer-readable storage medium. A processor of a computer device reads the computer instructions from the computer-readable storage medium. The processor executes the computer instructions, so that the computer device performs the method provided according to aspects illustrated in FIG. 2 or FIG. 4.

What is disclosed above is merely illustrative and does not limit the scope of the aspects described herein.

What is claimed is:

1. A computing method, comprising:
obtaining a virtual scene, wherein the virtual scene comprises:
a camera, wherein the camera is a component configured to present a view of the virtual scene in a direction of at least one viewing angle, and
one or more virtual objects;
generating a plurality of surface elements in the virtual scene, wherein a surface element is a plane figure having a direction and a size and wherein each virtual object has at least one surface element attached to a surface of each virtual object;
obtaining, for each surface element of the plurality of surface elements, a depth value of the surface element, wherein the depth value is a distance value between each surface element and the camera; and
constructing, based on the obtained depth values, full-viewing-angle depth information of the virtual scene.

2. The method according to claim 1, wherein constructing full-viewing-angle depth information of the virtual scene further comprises:
obtaining a mapping template, wherein the mapping template comprises a plurality of pixels;
projecting a surface element in the plurality of surface elements to the mapping template, wherein projecting the surface element comprises obtaining a pixel in the mapping template and wherein the pixel corresponds to the surface element; and
storing, in the pixel corresponding to the surface element, the obtained depth value for the surface element.

3. The method according to claim 2, wherein projecting the surface element to the mapping template further comprises:
obtaining, for the surface element, a direction vector between a center point of the surface element and the camera;
projecting, based on the direction vector, the center point of the surface element to the mapping template,
obtaining, based on the projected center point, a first projection point; and
determining that a pixel in the mapping template located at the first projection point corresponds to the surface element.

4. The method according to claim 2, wherein storing the obtained depth value further comprises:
storing, in the corresponding pixel in the mapping template, the obtained depth value corresponding to the surface element;
obtaining, from the mapping template, a depth information map,
determining that the depth information map comprises an invalid pixel, wherein a pixel is invalid based on the pixel not storing a depth value; and
performing, based on an information reconstruction policy, information reconstruction on the invalid pixel; and
obtaining a reconstructed depth information map, wherein the reconstructed depth information map is the full-viewing-angle depth information of the virtual scene.

5. The method according to claim 4, wherein performing information reconstruction on the invalid pixel further comprises:
generating, based on the depth information map and for each level of the depth information map, a low-precision information map;
obtaining, based on the low-precision information map, a target information map, wherein the target information map comprises:
a pixel,
a depth value stored in the pixel, and
each depth value stored in a pixel in a (k+1)^{th}-level information map which is determined based on depth values stored in a plurality of pixels in a k^{th}-level information map; and
storing, in the invalid pixel in the target information map, a depth value for the invalid pixel, wherein:
the depth value for the invalid pixel is determined based on one or more depth values stored in one or more valid pixels in the (k+1)^{th}-level information map, and a lowest level map is the depth information map.

6. The method according to claim 5, wherein the generating a low-precision information map based on the depth information map further comprises:
grouping one or more pixels in the k^{th}-level information map;
determining, based on the grouped pixels, an image template used for generating the (k+1)^{th}_level information map, wherein:
no pixel in the image template stores a depth value,
one pixel in the image template corresponds to one pixel group in the grouping result, and
different pixels correspond to different pixel groups;
traversing a pixel in the image template;
obtaining a pixel group corresponding to the traversed pixel from the grouped pixels;
selecting one or more valid pixels from the obtained pixel group, wherein a valid pixel is a pixel storing a depth value;
calculating an average depth value of the selected valid pixels; and
storing the depth value in the traversed pixel.

7. The method according to claim 5, wherein filling an invalid pixel in a high-precision information map based on the target information map comprises:
traversing the invalid pixel in the k^{th}-level information map in the high-precision information map;
obtained a mapping point by mapping the traversed invalid pixel to the level-level information map;
selecting, based on the mapping point, one or more referenced pixels from the level-level information map;
calculating a depth value for the traversed invalid pixel based on a depth value stored the reference pixels;
storing the calculated depth value in the traversed invalid pixel.

8. The method according to claim 7, wherein the calculating the depth value for the traversed invalid pixel based on a depth value stored in the reference pixels further comprises:
weighting each reference pixel based on a distance between each reference pixel and the mapping point, wherein distance is inversely proportional to weight;
validating each reference pixel, wherein a reference pixel is valid based on storing a depth value; and
calculating, based on weights and depth values of the valid reference pixels, a weighted average of the depth values stored in the valid reference pixels, wherein the weighted average is the depth value.

9. The method according to claim 2, wherein a shape of a surface element is a circle and projecting the surface element from the virtual scene to the mapping template further comprises:
projecting, from the virtual scene and based on a direction vector between a center point of the surface element and the camera, a corresponding center point on the mapping template;
obtaining a first projection point based on the corresponding center point projected to the mapping template;
projecting, from the virtual scene and based on a direction vector between an edge point of the surface element and the camera, a corresponding edge point on the mapping template;
obtaining, based on the corresponding edge point, a second projection point;
drawing a circular region on the mapping template by using the first projection point as a circle center and a distance between the first projection point and the second projection point as a radius; and
wherein each pixel located in the circular region is a pixel corresponding to the surface element.

10. The method according to claim 2, further comprising:
obtaining surface element information of the surface element, wherein the surface element information comprises:
a radius,
world space coordinates of a center point, and
a normal vector;
determining, based on the surface element information, an edge of the surface element; and and
selecting a point from the determined edge as the edge point of the surface element.

11. The method according to claim 2, wherein the projecting the surface element to the mapping template further comprises:
selecting, for the surface element, K edge points from an edge of the surface element, wherein K is an integer greater than 2;
projecting, based on a direction vector between each edge point in the K edge points and the camera, K corresponding edge points on the mapping template, wherein K corresponding edge points are K second projection points;
obtaining a closed region on the mapping template by connecting, in sequence, the K second projection points on the mapping template; and
wherein a pixel in the closed region corresponds to the surface element.

12. The method according to claim 2, further comprising:
obtaining, based pixels in the mapping template storing depth values for one or more surface elements, a depth information map; and
wherein the depth information map is the full-viewing-angle depth information of the virtual scene.

13. The method according to claim 2, further comprising:
determining, based on a normal vector of the surface element and an image plane of the camera, that the surface element and the image plane of the camera are perpendicular to each other; and
projecting a center point of the surface element to the mapping template.

14. The method according to claim 2, further comprising:
determining, based on a normal vector of the surface element and an image plane of the camera, that the surface element and the image plane of the camera are parallel to each other; and
projecting a center point and an edge point of the surface element to the mapping template.

15. The method according to claim 2, further comprising:
determining, based on a normal vector of the surface element and an image plane of the camera, that the surface element and the image plane of the camera are oblique to each other; and
projecting a plurality of edge points of the surface element to the mapping template.

16. One or more non-transitory computer readable media comprising computer readable instructions which, when executed, configure a data processing system to perform:
obtaining a virtual scene, wherein the virtual scene comprises:
a camera, wherein the camera is a component configured to present a view of the virtual scene in a direction of at least one viewing angle, and
one or more virtual objects;
generating a plurality of surface elements in the virtual scene, wherein a surface element is a plane figure having a direction and a size and wherein each virtual object has at least one surface element attached to a surface of each virtual object;
obtaining, for a surface element of the plurality of surface elements, a depth value of the surface element, wherein the depth value is a distance value between the surface element and the camera; and
constructing, based on the obtained depth values, full-viewing-angle depth information of the virtual scene.

17. The one or more non-transitory computer readable media comprising computer readable instructions of claim 16, wherein constructing the full-viewing-angle depth information of the virtual scene further comprises:
obtaining a mapping template, wherein the mapping template comprises a plurality of pixels, and one pixel corresponds to one depth value;
projecting a surface element in the plurality of surface elements to the mapping template, wherein projecting the surface element comprises obtaining a pixel in the mapping template and wherein the pixel corresponds to the surface element; and
storing, in the pixel corresponding to the surface element, the obtained depth value.

18. A system, comprising:
a processor; and
memory storing computer readable instructions which, when executed, configure the system to perform:
obtaining a virtual scene, wherein the virtual scene comprises:
a camera, wherein the camera is a component configured to present a view of the virtual scene in a direction of at least one viewing angle, and
one or more virtual objects;
generating a plurality of surface elements in the virtual scene, wherein a surface element is a plane figure having a direction and a size and wherein each virtual object has at least one surface element attached to a surface of each virtual object;
obtaining, for a surface element of the plurality of surface elements, a depth value of the surface element, wherein the depth value is a distance value between the surface element and the camera; and
constructing, based on the obtained depth values, full-viewing-angle depth information of the virtual scene.

19. The system according to claim 18, wherein constructing the full-viewing-angle depth information of the virtual scene further comprises:
obtaining a mapping template, wherein the mapping template comprises a plurality of pixels, and one pixel corresponds to one depth value;
projecting a surface element in the plurality of surface elements to the mapping template, wherein projecting the surface element comprises obtaining a pixel in the mapping template and wherein the pixel corresponds to the surface element; and
storing, in the pixel corresponding to the surface element, the obtained depth value.

20. The system according to claim 19, wherein the projecting the surface element to the mapping template further comprises:
selecting, for the surface element, K edge points from an edge of the surface element, wherein K is an integer greater than 2;
projecting, based on a direction vector between each edge point in the K edge points and the camera, K corresponding edge points on the mapping template, wherein K corresponding edge points are K second projection points;
obtaining a closed region on the mapping template by connecting, in sequence, the K second projection points on the mapping template; and
wherein a pixel in the closed region corresponds to the surface element.
